(19) United States
(12) Patent Application Publication
(10) Pub. No.: US 2025/0188738 A1
(43) Pub. Date: Jun. 12, 2025

(54) PRINTED BASE STRUCTURE ADAPTED FOR THE SUBSEQUENT DECORATION BY AN ARTIST

(71) Applicants: Matthew Earl Meyer, North Salt Lake, UT (US); Alexander William Tollington, Fort Wayne, IN (US); Darren Michael Baldwin, Lebanon, OH (US)

(72) Inventors: Matthew Earl Meyer, North Salt Lake, UT (US); Alexander William Tollington, Fort Wayne, IN (US); Darren Michael Baldwin, Lebanon, OH (US)

(21) Appl. No.: 18/766,235

(22) Filed: Jul. 8, 2024

Related U.S. Application Data
(60) Provisional application No. 63/525,473, filed on Jul. 7, 2023.

(51) Int. Cl. E04B 2/74; B33Y 80/00; B44C 1/28

(52) U.S. Cl. CPC E04B 2/7407; B44C 1/28; B33Y 80/00

(57) ABSTRACT

3D printed base structure and methods of 3D printing base structures are provided. In one implementation, for example, a printed base structure is adapted for subsequent decoration by an artist. The printed base structure has a plurality of layers of a 3D printable material. The 3D printed base structures may include joinery systems to allow the structure to be attached to a second printed base structure or a field-bent bar structure. In another embodiment, a printed base structure is adapted for the subsequent decoration by an artist in which the printed base structure is constructed of a plurality of structure segments.

### CROSS-REFERENCE TO RELATED APPLICATIONS

This application claims the benefit of U.S. provisional application No. 63/525,473, filed Jul. 7, 2023, which is hereby incorporated by reference as though fully set forth herein.

### FIELD

This invention relates to a printed base structure adapted for the subsequent decoration by an artist. More specifically, this invention relates to a 3d printed base structure that make faster and cheaper the manufacture and installation of decorated structures like themed walls and waterfall structures.

### BACKGROUND

Traditional approaches for making decorated concrete walls are time consuming, labor intensive, expensive, plus they are often made using a metal super structure that will ultimately rust. What is needed is a fast, cheaper and better way to make decorated walls and the like, in particular using 3d printing of concrete-like materials (e.g., high strength poly grout).

### SUMMARY

3D printed base structure and methods of 3D printing base structures are provided. In one implementation, for example, a printed base structure is adapted for subsequent decoration by an artist. The printed base structure has a plurality of layers of a 3D printable material.

The 3D printed base structures may include joinery systems to allow the structure to be attached to a second printed base structure or a field-bent bar structure.

In another embodiment, a printed base structure is adapted for the subsequent decoration by an artist in which the printed base structure is constructed of a plurality of structure segments.

In yet another embodiment, printed modular panels adapted for the subsequent decoration by an artist are provided. A printed modular assembly is constructed of a plurality of printed modular panels; and modular supports being affixed to said printed modular panels.

In another embodiment, a printed dwelling being able to be printed at a remote location is provided. The printed dwelling comprises a printed wall structure adapted to provide the benefits of a dwelling; and a disposable print form that allows for the printing of said printed wall structure. The disposable print form being disposable after the completion of said printing.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale.

FIG. 1A is an example of a faux desert rock work motif.

FIG. 1B is an example of a faux sub alpine rock work motif.

FIG. 1C is an example or a fantasy island faux rock work motif.

FIG. 1D is an example of a fantasy ancient Aztec faux architectural motif.

FIG. 1E is a photo showing final stages of faux rockwork construction.

FIG. 1F is an artistic ideation of alpine rock work scene.

FIG. 2A is a front view photo showing placement of pipe (110) and mesh (120) forming a base structure (100).

FIG. 2B is a front view photo showing an initial fill shotcrete coat (130) on the base structure (100).

FIG. 2C is a side corner view photo showing an initial fill coat of shotcrete (130) on the base structure (100).

FIG. 2D is a front view photo showing the base artistic coat (140) on the shotcrete (130).

FIG. 2E is a front view photo showing a detail artistic coat (150) on the shotcrete base artistic coat (140).

FIG. 2F is a side aerial view photo of a completed structure being moved into location with the use of a crane.

FIG. 3A is a perspective view of the gantry based 3D Printer (180)

FIG. 3B is a perspective view of robotic arm 3D Printer (190)

FIG. 4A is a cut away perspective view of the print head (195) shown in FIG. 3A, printing the base layer of material for the base structure (200).

FIG. 4B is a cut away perspective view of the print head (195) shown in FIG. 3A, showing 25% layer deposition progress of the base structure (200).

FIG. 4C is a cut away perspective view of the print head (195) shown in FIG. 3A, showing 50% layer deposition progress of the base structure (200).

FIG. 4D is a perspective view of the completed print of the base structure (200).

FIG. 4E is a perspective view showing an artist applying the artistic final coat (150) to the base structure (200).

FIG. 4F is a perspective view showing a cut away robotic arm applying an artistic final coat (150) to the base structure (200).

FIG. 4G is a perspective view showing a fully coated base structure (200).

FIG. 4H is a front view photo showing a non-coated base structure (200).

FIG. 4I is a front view photo showing a non-coated base structure (200).

FIG. 5A is a front view illustration of the structural segments (202A-202C) and related divisions forming a specific rock wall water feature (000).

FIG. 5B is a cut away perspective view of the rock wall water feature (000) shown in segments (202A-202C) in positional placement relation to the structure.

FIG. 5C is a perspective view of the segments (202A-202C) from FIG. 5B showing the printed objects for reference.

FIG. 5D is a front view illustration of FIG. 5A showing the artistic final coat overlay (150) in relation to the base structure segments (200).

FIG. 5E is a front view artistic rendering of the completed functional rock wall water feature (000).

FIG. 6A is a perspective view showing the dimensional scalability of the decorated printed structures (250).

FIG. 6B is a perspective view showing an assembly (300) of printed modular panels (310) forming a simple structure (250).

FIG. 6C is a perspective view showing a series of printed modular assemblies (300) series of simple structures (250).

FIG. 6D is an exploded view showing a series of printed modular panels (310) which form a simple structure (250).

FIG. 6E is an exploded view showing a series of printed modular panels (310) illustrating the relationship to modular supports (320).

FIG. 6F is an exploded view showing a series of printed modular panel supports (320).

FIG. 6G is an exploded view showing a series of printed modular panels (310).

FIG. 7A is an exploded view showing the relationship of the printed panels (310) in relationships to other components.

FIG. 7B is a perspective view showing an assembled panel from FIG. 7A and its related components.

FIG. 7C is a cutaway side view showing the relationship between the supported print panel (330) and the position able armature (340).

FIG. 7D is a cutaway right side view showing the relationship between multiple supported print panels (330) and the position able armatures (340).

FIG. 7E is a rear right perspective view showing the relationship between FIG. 7E and a support post (350).

FIG. 7F is a rear left perspective view showing the relationship between FIG. 7E, the strut supports (360) and the support post (350).

FIG. 7G is a front left perspective view showing the relationship between FIG. 7E and the position able armatures (340) mounted to an existing wall (370).

FIG. 8A is a cross section illustration of a faux mountain feature showing a uniform section of the modular panel system (380).

FIG. 8B is an illustration showing additional panels circumferentially at the base of FIG. 8A.

FIG. 8C is an illustration showing the completely enclosed faux mountain feature of FIG. 8A.

FIG. 9A is a front left perspective view of a faux buffalo sculpture and faux landscape rocks that are built with the modular panel system (380).

FIG. 9B is a close-up left front perspective view illustration of the faux buffalo sculpture shown in FIG. 9A.

FIG. 10 is a front left perspective view of a self-supporting rock climbing (bouldering) wall built with the modular panel system (380).

FIG. 11A is a front left perspective view of a rock-climbing wall built with the modular panel system (380) and anchored to existing post (192) structures.

FIG. 11B is a front left perspective view of a series of modular rock-climbing walls built with the modular panel system (380) and anchored to existing walls (370).

FIG. 12A is a front left perspective view of a waterslide built with a variation of the modular panel system (cylinder print) (380) and related components.

FIG. 12B is a top view of the waterslide shown in FIG. 12A.

FIG. 12C is a front left perspective cross section view a print path (202) with a flanged joint (382) and joint tabs (382c).

FIG. 12D is a front left perspective view of the with flanged joint (382) and joint protrusions (382b).

FIG. 13A is a building (194) showing the use of a modular façade system (400).

FIG. 13B is a front left perspective view of modular façade system (400) sections attached to an existing wall (194).

FIG. 14A is a top perspective cut away view of a printed base structure (200) showing recess (392) with an elevated retention clip (390).

FIG. 14B is a cross-section side view of the base material print path (202), recess (392) and retention clip (90).

FIG. 15A is a front right perspective view of a printed base structure (200) being printed against a form (410).

FIG. 15B is a left rear perspective view of a printed base structure (200) being printed against a form (410).

FIG. 16A is a top view showing the lay down feeder (198) dispensing stock material (500) in a patterned fashion.

FIG. 16B is a cutaway perspective view showing the lay down feeder (198) and spool dispensing stock material (500) in a patterned fashion.

FIG. 16C is a top view showing the lay down feeder (198) and spool dispensing stock material (500) in a patterned fashion.

FIG. 16D is a top view showing the lay down feeder (198) dispensing stock material (500) in a patterned fashion.

FIG. 16E is a left rear perspective view of a printed base structure (200) with stock material (500) positioned in a pattern fashion.

FIG. 17 is a left side perspective view of a printed base structure (200) with the addition of a vapor barrier (510) and insulation (520).

FIG. 18 is a right rear perspective view of a printed base structure (200) with the addition of a vapor barrier (510) and utilities (530a & 530 B) organized by the stock material.

FIG. 19A is a cutaway perspective view showing the lay down feeder (198) dispensing joint tabs (382C) linearly.

FIG. 19B is a top view showing the lay down feeder (198) dispensing joint tabs (382C) around the base structure (200).

FIG. 19C is a left rear perspective view of a printed base structure (200) with joint tabs (382C) in a pattern fashion.

FIG. 20A is a front right perspective view of a printed base structure (200) with four sides for cutting at corners (312).

FIG. 20B is a front right perspective view of a printed base structure (200) with four sides cut at four corners (312) creating four individual panels (310).

FIG. 21A is a right rear perspective view of a printed base structure (200) being printed against a form (410).

FIG. 21B is a front left perspective view of a semi spherical base structure (200) being printed against a form (410).

FIG. 22A is a rear left close up view of the panel system with emphasis on the panel joining methods (600) and the cold joint (610).

FIG. 22B is a cross-section side view of the base structure material (200) and the cold joint (610).

FIG. 22C is a cross-section side view of the base structure material (200) and the cold joint (610) during freeze thaw, cyclic loading, or vibration and shaking.

FIG. 22D is a cross-section side view of the base structure material (200) and the expansion joint (600).

FIG. 22E is a cross-section side view of the base structure material (200) and the expansion joint (600) during freeze thaw, cyclic loading, or vibration and shaking.

FIG. 22F is a rear left close up view of the panel system with emphasis on the waterproof coating method (620).

FIG. 22G is a cross-section side view of the base structure material (200) and waterproof coating method (620).

FIG. 23A is a cutaway perspective cross section view of the alignment assembly (630).

FIG. 23B is a cutaway perspective cross section view of the alignment assembly (630) placed in the base structure material. (200).

FIG. 23C is a cross-section view of the alignment assembly (630) placed in the base structure material. (200).

FIG. 24A is a top view of a printed base structure (200) filled with strengthening material (650).

FIG. 24B is a cutaway perspective cross section view of the printed base structure (200) filled with strengthening material (650).

FIG. 25 is a front left perspective view of the modular panel system (380) compensating for shaking and vibration.

FIG. 26A is a side view of the modular panel system (380) joining mechanism (FIG. 26B) in articulated positions showing relation to the expansion joint (600) and mounting brackets (667)

FIG. 26B is a side view of the modular panel system joining mechanism showing the damper (664) and adjustable dial (662) for predetermined degree articulation.

FIG. 27A is a side view showing the seismic safety assembly (700) mounted to the modular panel (330).

FIG. 27B is a side view showing the seismic safety assembly (700) mounted to the supported print panel (330) in an activated state.

FIG. 27C is a side view showing the seismic safety assembly (700) mounted to the supported print panel (330) in an activated state.

FIG. 27D is a side view showing the seismic safety assembly (700) mounted in a truss formation.

FIG. 28A is an illustration of an existing rock feature (800) showing a crack (805).

FIG. 28B is an illustration of an existing rock feature (800) showing a crack section being cut out (807).

FIG. 28C is an illustration of an existing rock feature (800) showing a crack section being removed (807).

FIG. 28D is an illustration of an existing rock feature (800) showing a crack section being replaced with a predesigned modular panel (330).

FIG. 29A is a photo of a clay model ideation (900) representing a faux rock water feature.

FIG. 29B is a photo of a plastic (910) printed model of the clay model (900) representing a faux rock water feature.

FIG. 29C is a photo of an altered ideation (920) of a previous version (FIG. 29B) representing a faux rock water feature.

FIG. 29D is a photo of a digital scan (925) of (920) representing a faux rock water feature.

FIG. 29E is a rendering (930) of a digital scan of (920) representing a faux rock water feature.

FIG. 29F is a print overhang analysis (935) of (920) representing a faux rock water feature.

FIG. 29G is a print overhang analysis (940) of (920) representing a digital mesh analysis.

FIG. 30A is a front view rendering of a digital scan of (920) for subdivision analysis model (945) representing a faux rock water feature.

FIG. 30B is a cross-section side view of (FIG. 30A) showing internal features.

FIG. 31 is a front view rendering of the faux decorated printed structure (250) in a its intended final form and function of a faux rock water feature.

FIG. 32A is a photo of a 3D printed statue (1000).

FIG. 32B is a photo of a concrete statue (1000).

FIG. 33A is a perspective view of a printed dwelling (1100) being lifted with a disposable print form (1120) being removed.

FIG. 33B is a perspective view of a printed wall form (1110) for a dwelling (1100) around a disposable print form (1120).

### DETAILED DESCRIPTION

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator such as a surgeon. Thus, for example, the tip or free end of a device may be referred to as the distal end, whereas the generally opposing end or handle may be referred to as the proximal end.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The term “substantially” as used herein may be applied to modify any quantitative representation which could permissibly vary without resulting in a change in the basic function to which it is related.

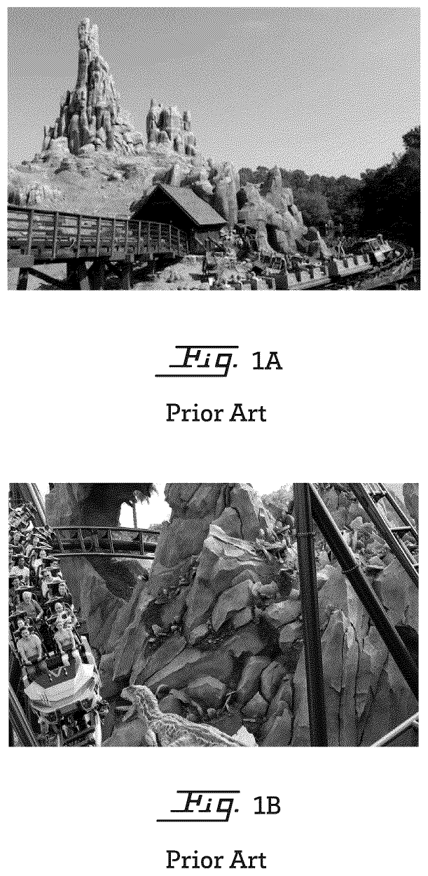

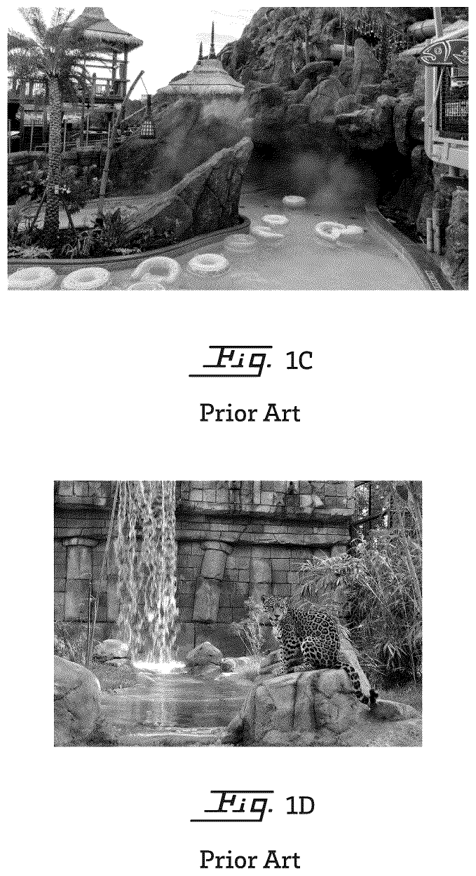

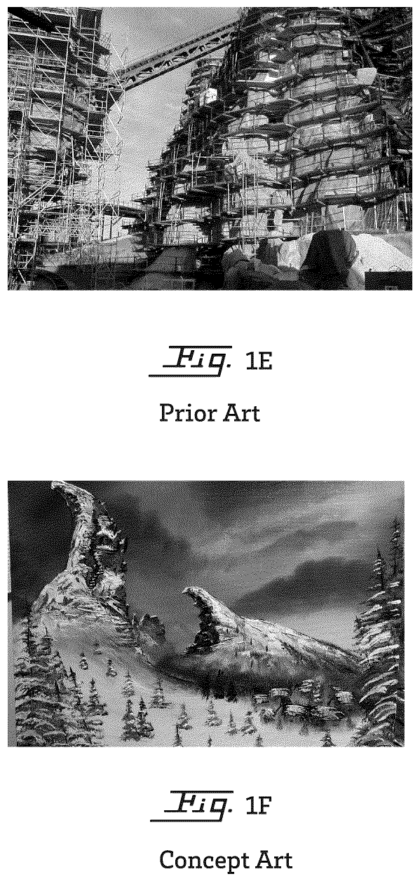

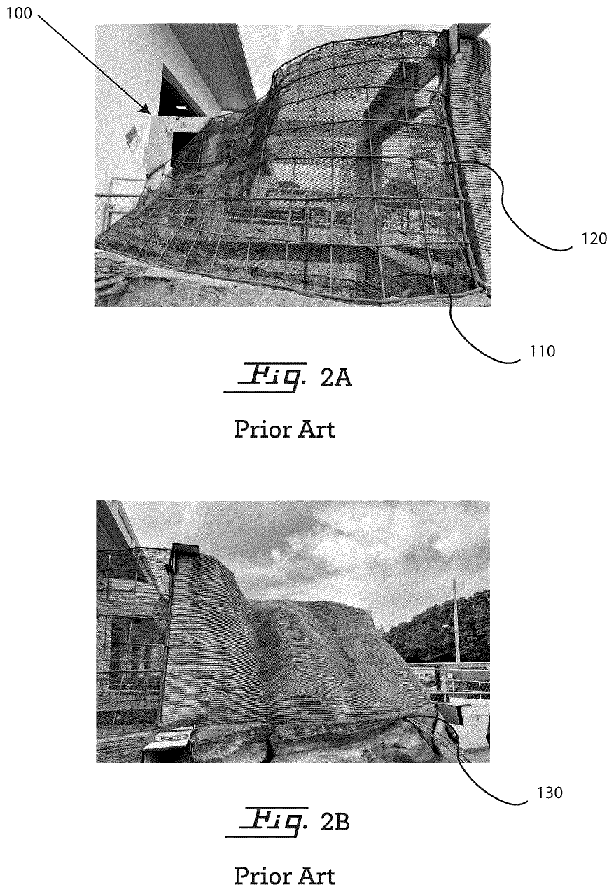

FIG. 1A shows an example of an amusement park as can be seen in the photo, it is common for amusement park owners to create rock wall facades to improve the overall aesthetics of the environment. FIG. 1B shows another example of an amusement park having rock wall facades. FIGS. 1C and 1D are also examples of rock wall facades within an amusement park. These facades (or structures) are often made using traditional approaches for making decorated concrete walls which are time consuming, labor intensive, expensive, plus they are often made using a metal super structure that will ultimately rust.

FIG. 1E shows a rock wall facade being constructed with the artist applying a final decorative coat.

FIG. 1F shows an example of a rock wall facade having overhang angles that extended outwardly to form a peak which is often difficult. One or more embodiments, however, are able to achieve these challenging overhang angles.

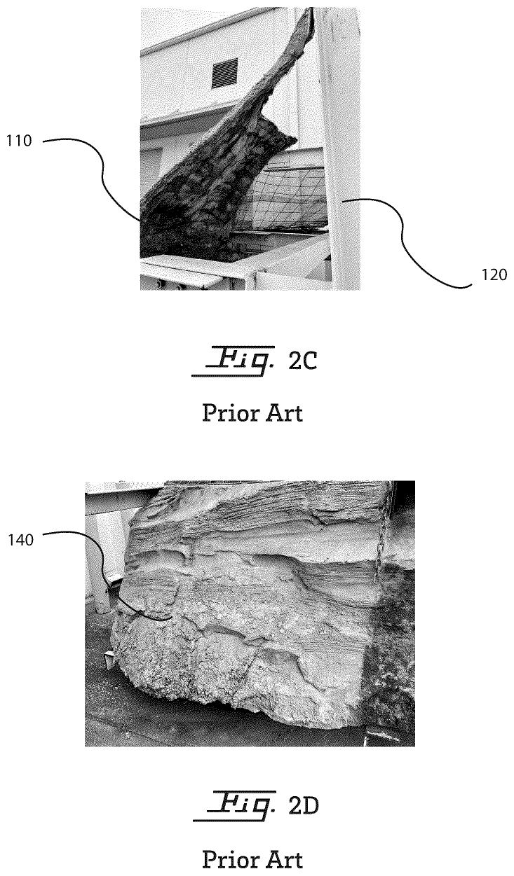

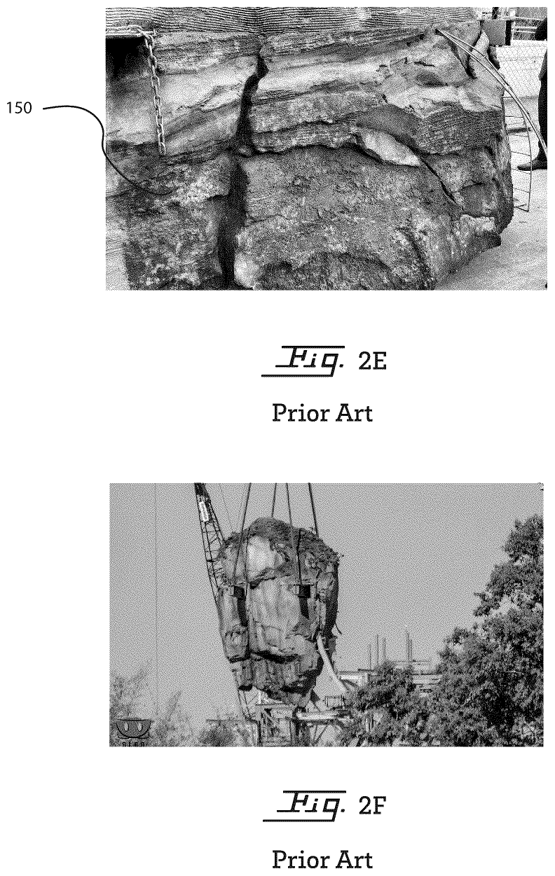

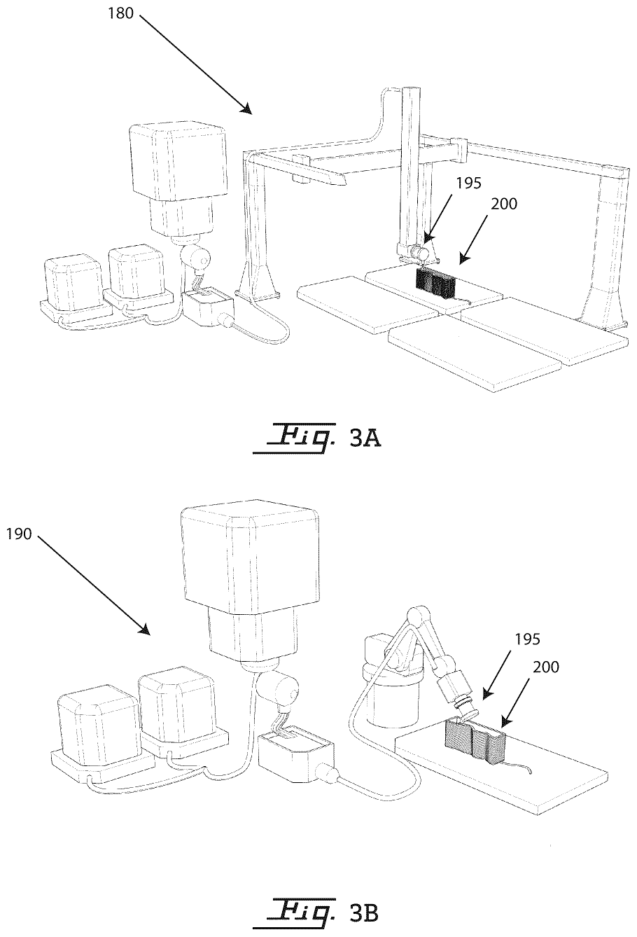

FIG. 2A shows an example showing how these rock wall facades are ordinarily constructed. More specifically, a metal superstructure 100 may comprise of a metal pipe frame 110, and metal mesh 120 which forms as the support structure for subsequent decoration. This metal superstructure 100 is very labor intensive and costly to install, plus, it will rust in a few years, thus requiring additional repairs or complete tear down and rebuild. This is a key problem that can be solved by one or more embodiments. FIG. 2B shows the same metal superstructure 100 with a base shotcrete coat applied. Here again, the application of base shotcrete coat 130 is very labor intensive and expensive. FIG. 2C shows a side view of the metal superstructure 100 shown within FIG. 2B. FIG. 2D shows the same metal superstructure 100, but now with a contoured base coat 140 being applied.

Here again, this contoured base coat 140 is labor intensive and tricky given the lack of proper foundational layer underneath. FIG. 2E shows an artistic final coat 150 being applied to the structure shown in FIG. 2D. FIG. 2F shows the final metal superstructure 100 now being decorated and being transported into place.

Typically, panel sizes are limited to maintain structural fidelity and due to safety concerns for workers handling and manipulating the panels. With respect to safety, the safe weight that a man can safely handle usually limits Chip and Tab to be 7′×7′ or max 8′×8′ (considered oversized). Height is often 7′ (or 2 meters) because this is limited to the height of reach for a man to do shotcrete, then carve and apply artwork. Width is usually limited to 7′ to 8′ because this is the safe weight for a man to handle and move within a welding jig and inside a factory.

Further, structural integrity is at risk where bars in the vertical or horizontal are over about 12′ because the thin bars of ⅜″ start to bend and lose their fidelity. Maximum panel size is 7′ because ⅜″ bar is flimsy and doesn't hold shape beyond 12′ in length. There may be 12′ of surface area in the x axis across 7′ of panel, because panels that represent rock are not flat. This constraint affects a single or plurality of panels that could otherwise be joined. This affects a single panel in terms of size, both in the vertical and horizontal dimension. This also affects preassembly of a plurality of panels that could otherwise be joined together. So, because of the limits of panel size mentioned above and assembly of panel(s) mentioned here, the current chip and tab approach results in merely 7′×7′ and as much as 7′×8″ in oversized situations (2 m×2 m).

In contrast to conventional systems, embodiments of printed panels are not limited in size in the same way. The systems provided herein allow for faster installation because of larger square foot of individual structures that are flown into place (e.g., placed with a crane) with fewer steps. With some printers, for example, panels may have heights up to 16′ based on limitations of the particular printers, with integrations for scaffolding, if needed, based on necessary access. Further, panels of widths up to 16′ may be manufactured based on structural engineering requirements (e.g., span, seismic, wind and weight). Printed panels may include their own structural fidelity and thus are not limited by the underlying steel rod structures of conventional panels. Thus, the printed embodiments provide significant enhancements.

3D concrete printed (3DCP) panels, in one embodiment, can be factory or field assembled using steel joinery and then flown into place in sections that are 2×, 3× or >4× the current being done with a crane (on the x or y axis). This would result in at least a 200%, 300% or >400% the current installation speed in setting panels with cranes. This also requires less crane time which is valuable on a project.

Bar is conventionally hand bent in the field allowing field art directors flexibility in defining last-minute features (i.e. characters, rock formations or MEP penetrations). Using a modular steel joinery system, 3DCP panels may be removed or changed in the field before or after install. This allows art directors feature flexibility in field for new construction or seasonal updates/changes. The joinery system allows for integration of 3DCP in smaller units or integration of field bent bars. Joinery is effectively the secondary steel moved to the panel in factory or field.

In some embodiments, joinery (such as shown herein) may be integrated with one or more 3DCP panels and provide increased flexibility. The joinery may allow for integration into existing field-bent bar systems, such as systems that are already in place. In this embodiment, for example, integrated joinery with a 3DCP panel may effectively serve as secondary steel of a conventional system

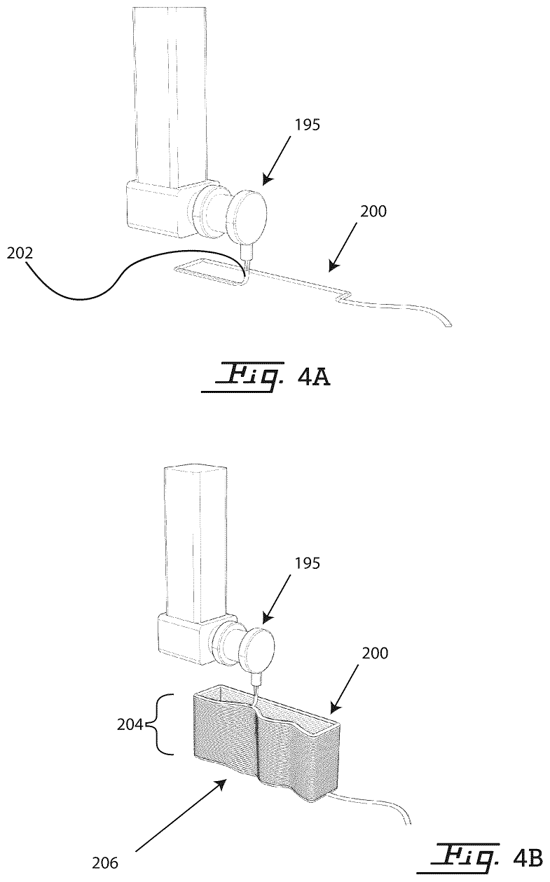

FIG. 3A shows a 3D printer, more specifically a Gantry 3D printer 180 commonly found in the marketplace. FIG. 3B shows an alternative printing, more specifically a robotic 3D printer 190. In both FIGS. 3A and 3B, it is shown a printer head 195 being used to create a printed base structure 200 (also known in the industry as the scratch coat).

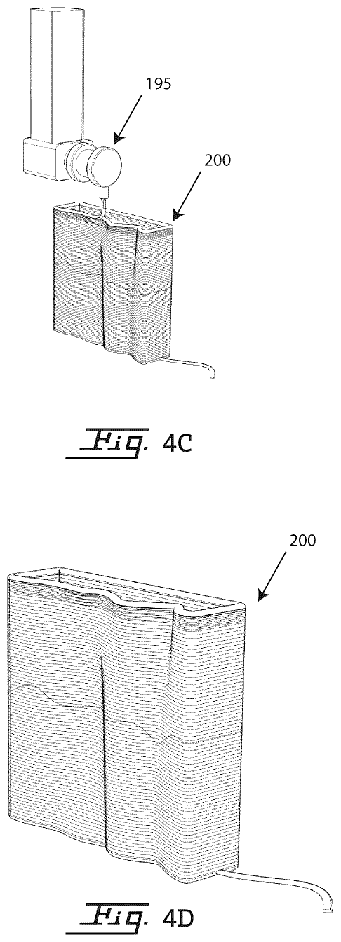

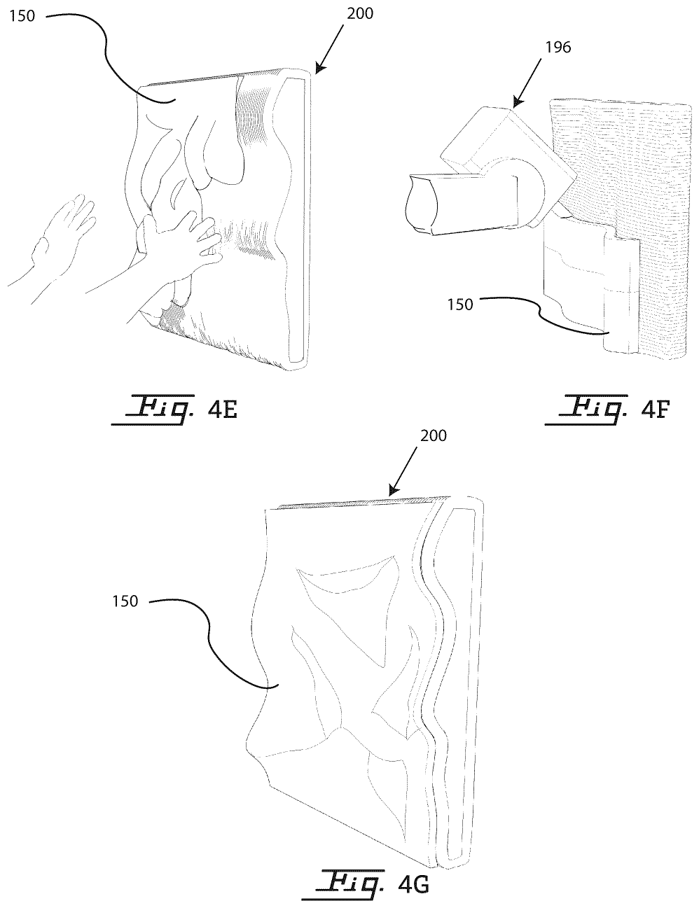

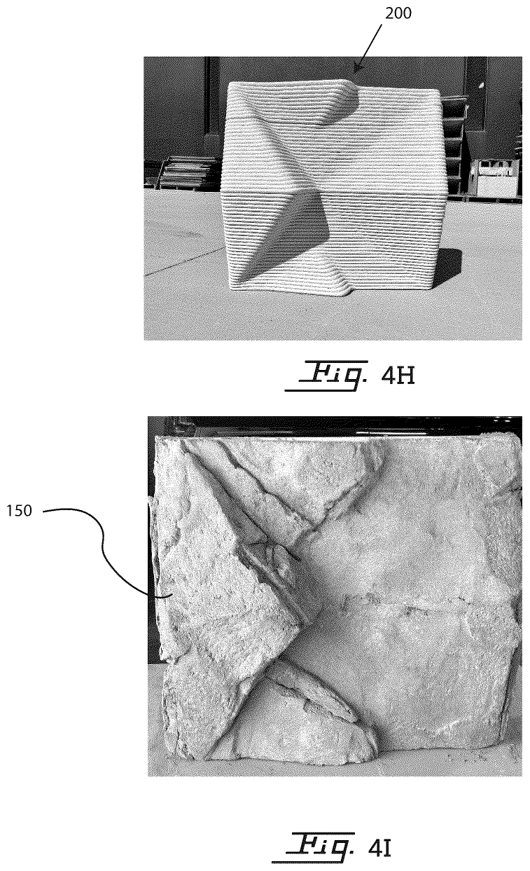

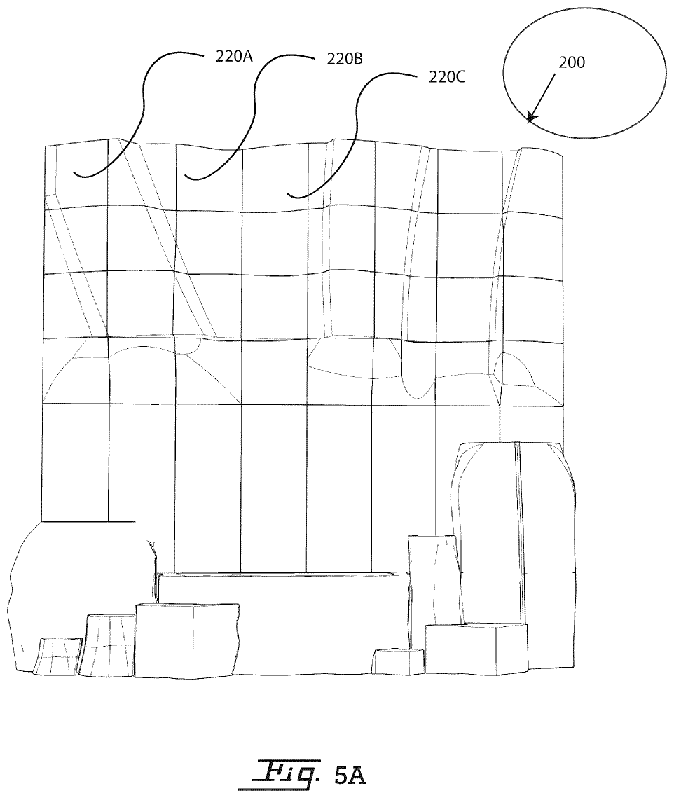

FIG. 4A shows printhead 195 in the early stages of creating printed base structure 200. Printhead 195 lays down a printable material 200 to begin the formation of printed base structure 200.

FIG. 4B shows the print head 195 at an elapsed time wherein layers of printable material 204 have now been formed. In this example, a nonlinear side 206 is shown and will be the underlying support structure for subsequent decoration by an artist. FIG. 4C shows printed base structure 200 nearly being completed by the printhead 195. FIG. 4D shows printed base structure 200 having been completed. FIG. 4E shows an artistic final coat 150 being applied by hand to printed base structure 200 and FIG. 4F shows an automated alternative approach. FIG. 4F shows an artistic final coat being applied to the base structure (scratch coat) 200 via an automated means, such as a robot arm 190. FIG. 4G shows the completion of the artistic final coat being adhered to printed base structure 200. FIG. 4H shows a depiction of the completed printed base structure 200 from FIG. 4D. FIG. 4I shows the artistic final coat 150 being applied to the printed base structure 200 found in FIG. 4H.

In another embodiment, the system may include a manipulator/actuator (such as the robot shown in FIG. 4F) that is used to manipulate the printed material of the printed base structure instead of or in addition to applying an additional final coat 150 being added to the printed base structure for artistic purposes. In yet another embodiment, the manipulator/actuator may be disposed on or near the 3D printer head. A rotating or otherwise manipulatable actuator may be disposed to manipulate the 3D printed material as or shortly after it is printed as the printed base material. In this manner, the surface of the 3D printed material may comprise an altered surface that serves an artistic function or is configured to enhance a later applied final coat 150. A robot arm (such as shown in FIG. 4F) and/or an actuator attached to a 3D printer head (such as shown in FIGS. 4A through 4C), for example, may be used to directly manipulate the printed base material as or shortly after it is printed.

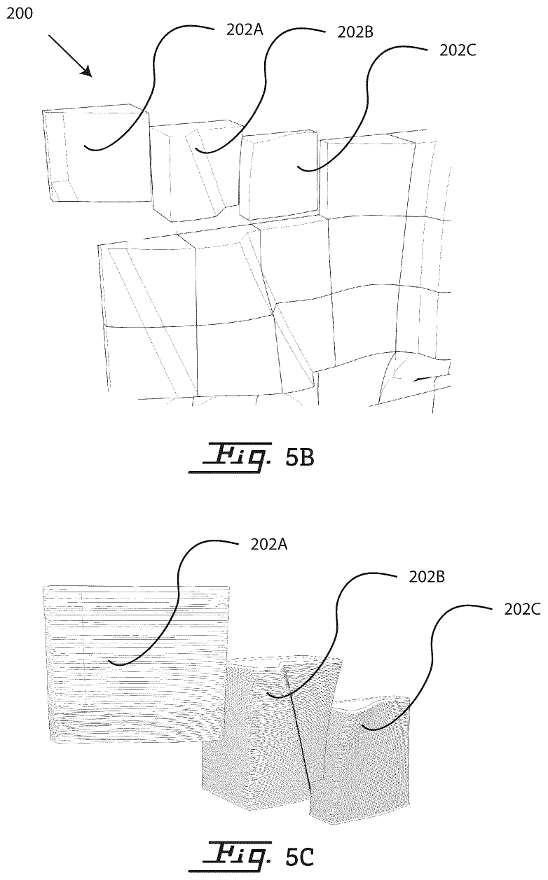

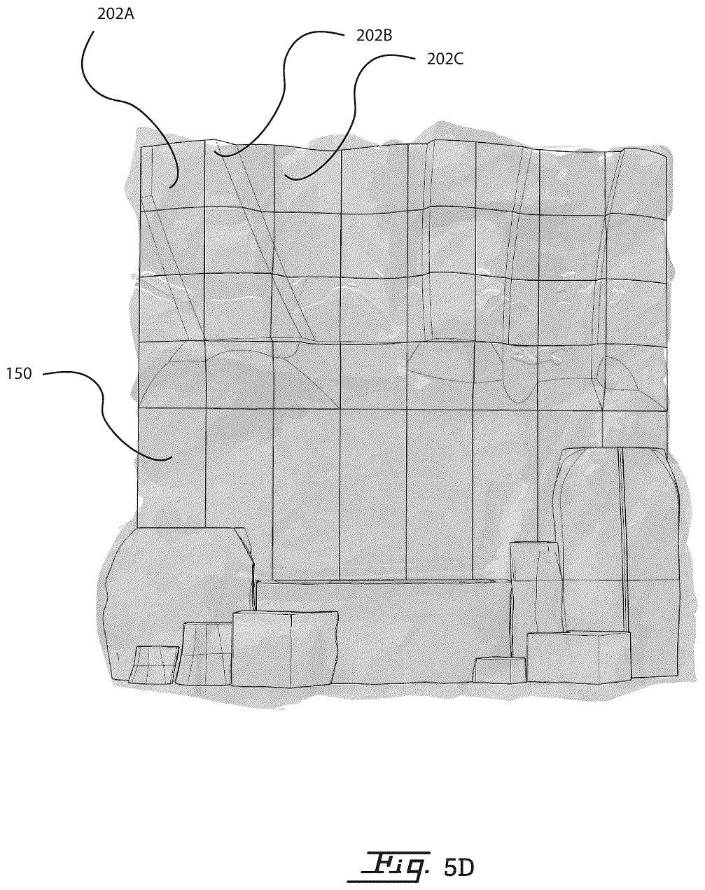

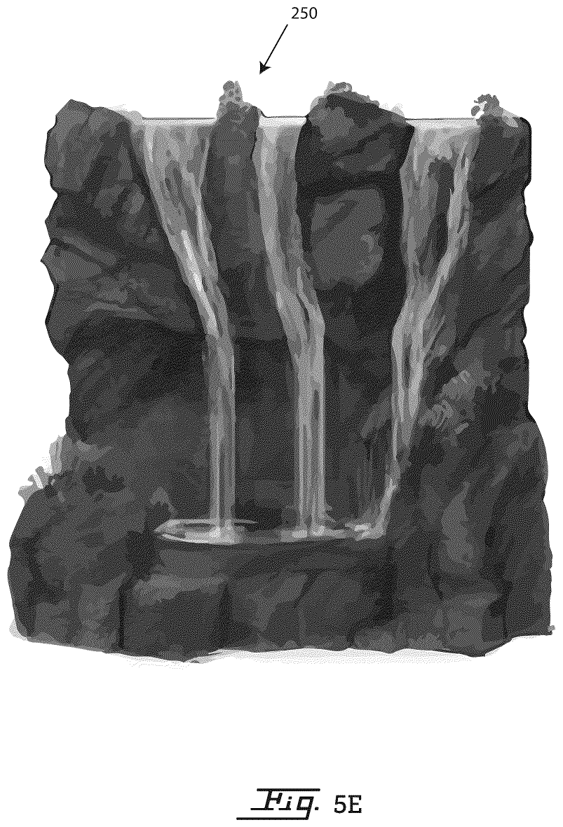

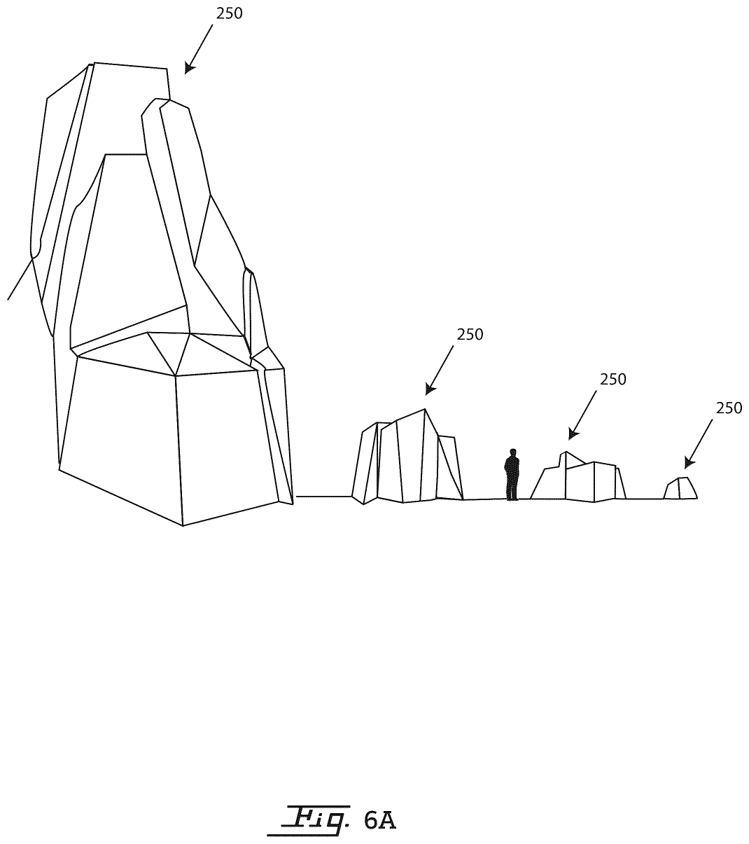

FIG. 5A shows a printed base structure 200 having been comprised of multiple structure segments 202A, 202B, 202C as one in the art would readily appreciate a plurality of structure segments can be combined to create an infinite number of structures, common sizes and configurations.

FIG. 5B shows structure segments 202A, 202B, 202C being inserted in place. FIG. 5C shows those same structure segments as printed base structures. Having layers of printable materials 204 being shown. FIG. 5D shows the printed base structure 205A now having an artistic final coat 150 being applied. FIG. 5E shows the final appearance having a waterfall and a collection pool shown.

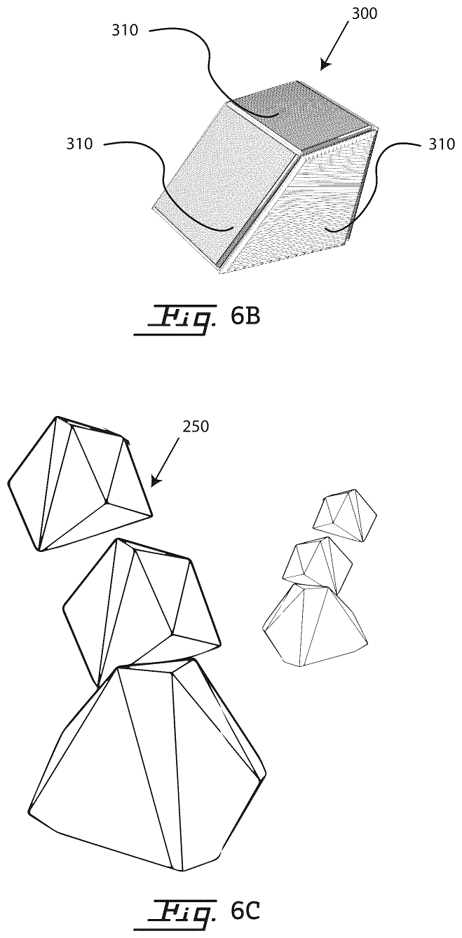

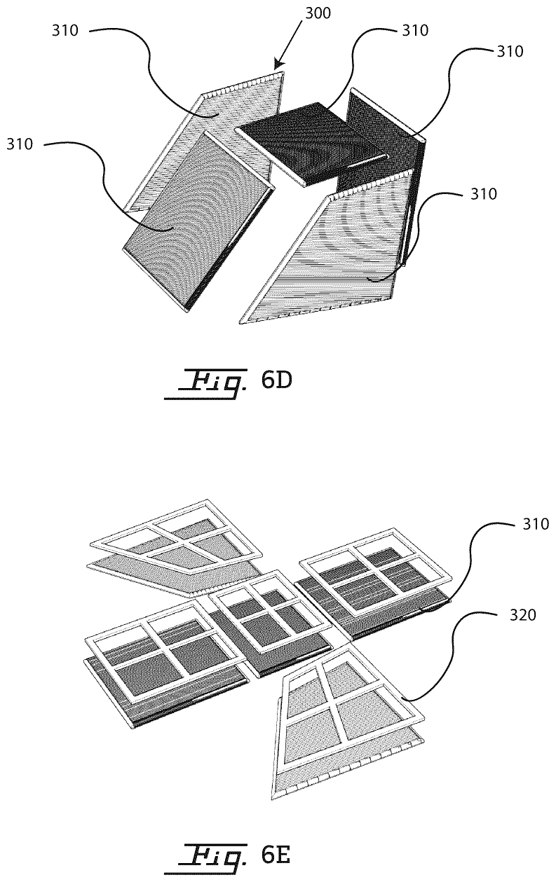

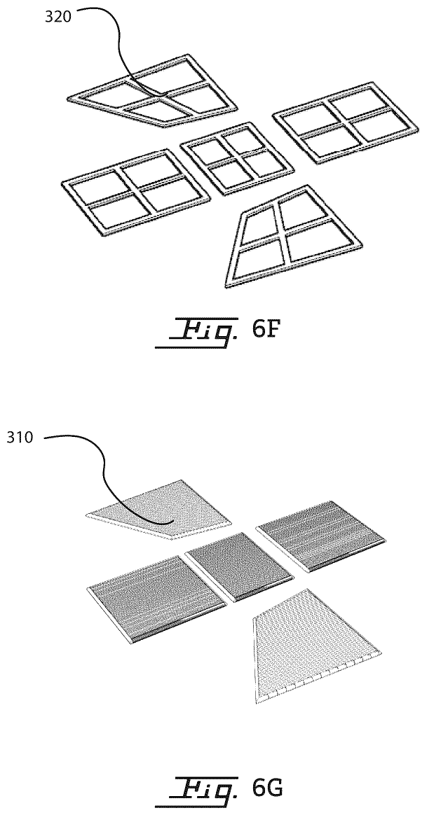

FIG. 6A illustrates the point that decorated printed structures 250 may be constructed in a variety of sizes and shapes. FIG. 6B shows a printed modular assembly 300 comprised of multiple printed modular panels 310. FIG. 6C shows how these printed modular panels 310 can be combined so as to create a larger decorated printed structure 250. FIG. 6D shows an alternative embodiment of a printed modular assembly 300 having 5 printed modular panels 310.

FIG. 6E shows those same printed modular panels 310 with modular supports 320 being affixed. FIG. 6F shows an example of suitable modular supports 320 FIG. 6G shows a matching configuration of printed modular panels 310.

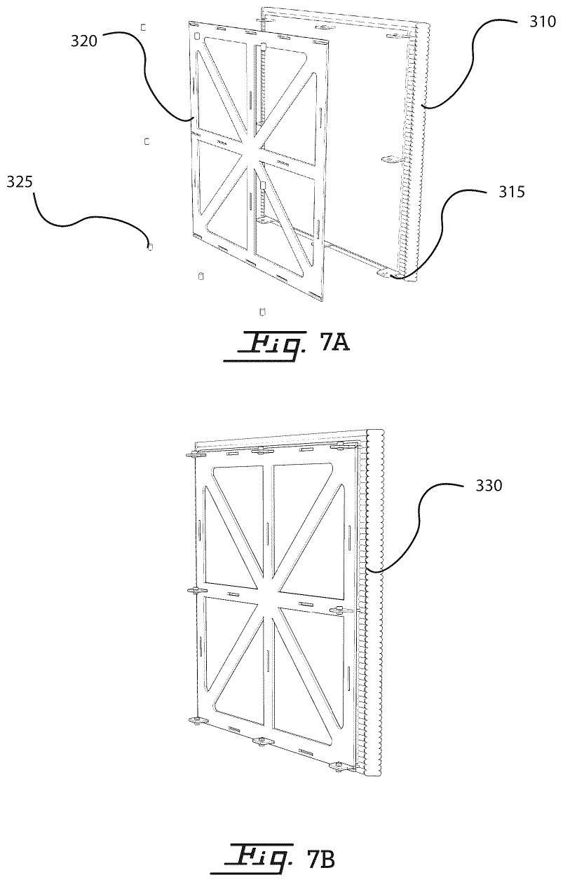

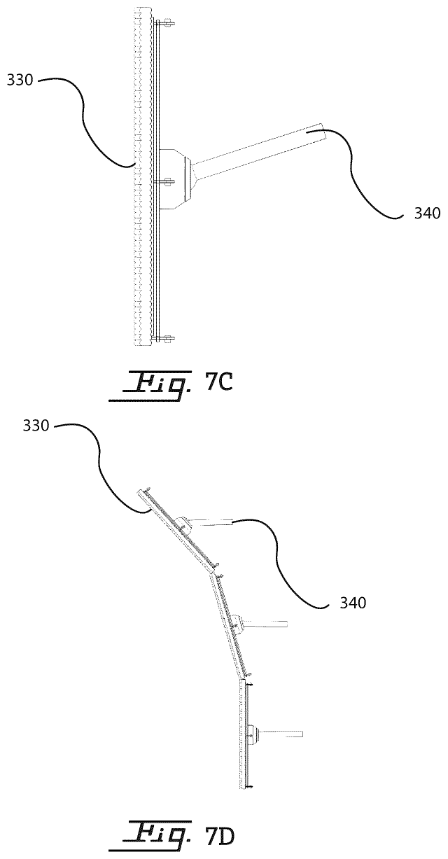

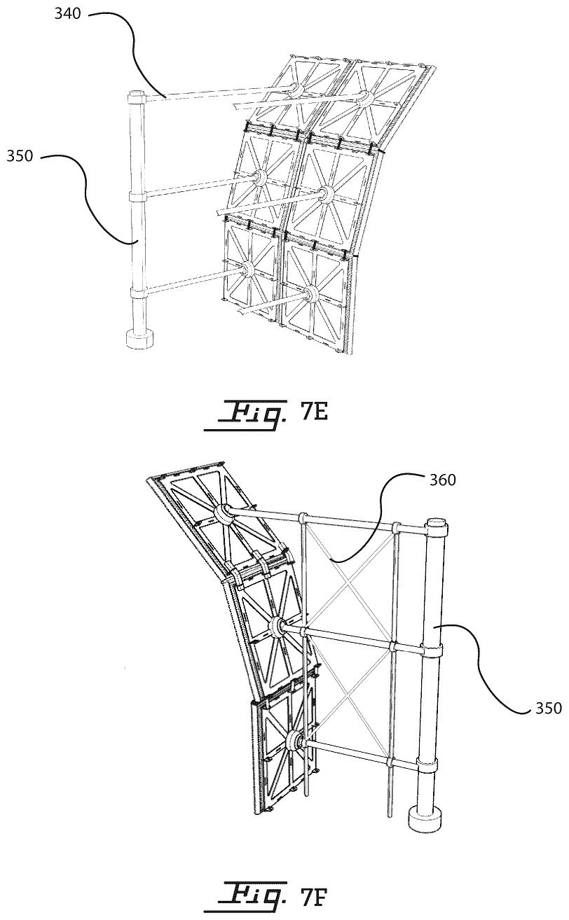

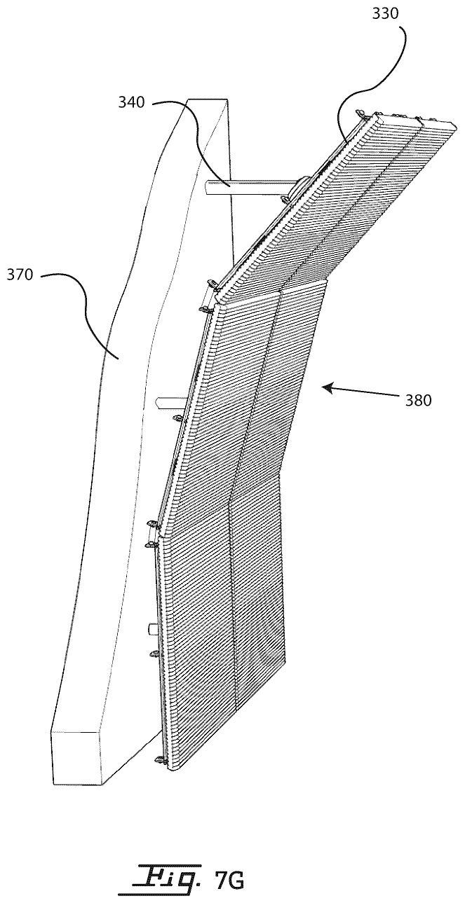

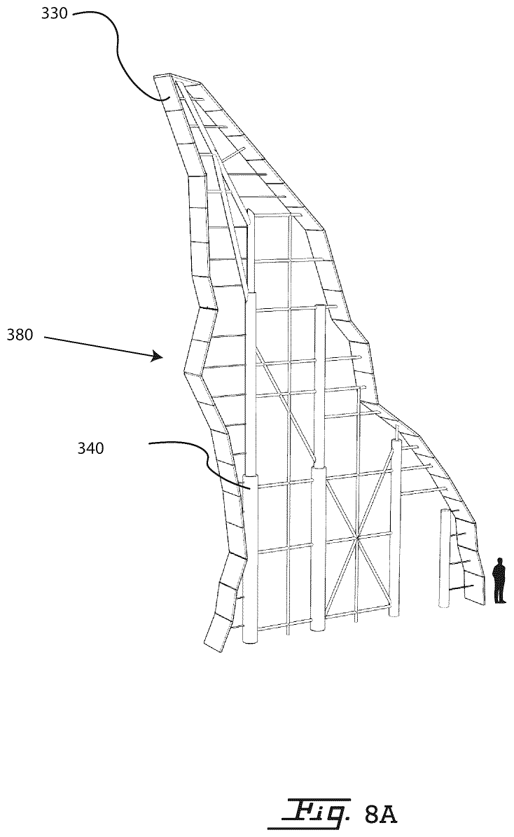

FIG. 7A shows printed modular panels 310 having panel brackets 315 so as to facilitate the connection of modular supports 320 with the use of attachment hardware at 325. FIG. 7B shows the components of FIG. 7A now being assembled. FIG. 7C shows the supported printed panel 330 now being attached to an armature 340. FIG. 7D shows a plurality of supported printed panels 330 with a plurality of armatures 340. FIG. 7E shows a post 350 being utilized so as to provide vertical support of said plurality of supported printed panels via armatures 340. FIG. 7F shows the addition of struts 360 to provide further structural integrity. FIG. 7G shows the assembly of FIG. 7F now being connected to a wall 370, perhaps of a building.

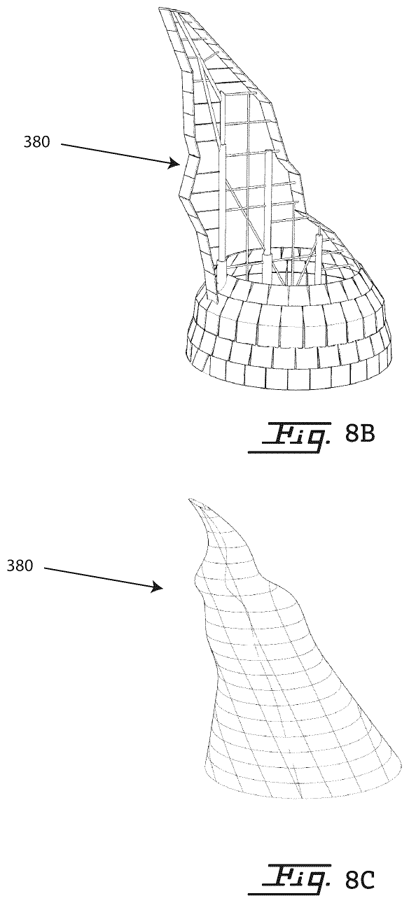

FIG. 8A shows that modular panel system 380 may be constructed at great heights so as to create many of the effects shown in FIGS. 1A through 1D. FIG. 8B shows the modular panel system 380 of FIG. 8A now being decorated on the backside. FIG. 8 C shows modular panel system 380 being fully decorated.

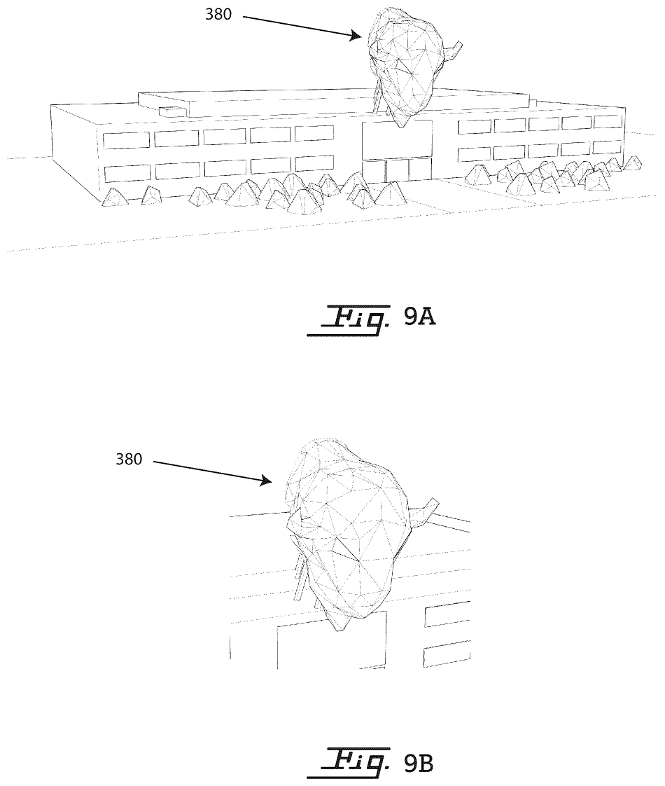

FIG. 9A shows a modular panel system 380 having the shape of a Buffalo which serves as a logo on top of a company's building. FIG. 9B is a close up of FIG. 9A.

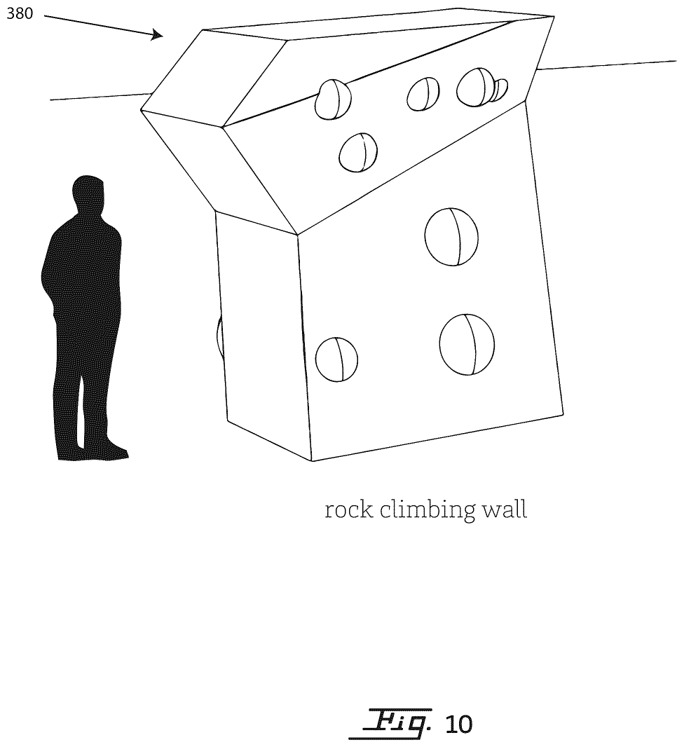

FIG. 10 shows a rock-climbing wall as being the form of modular panel system 380.

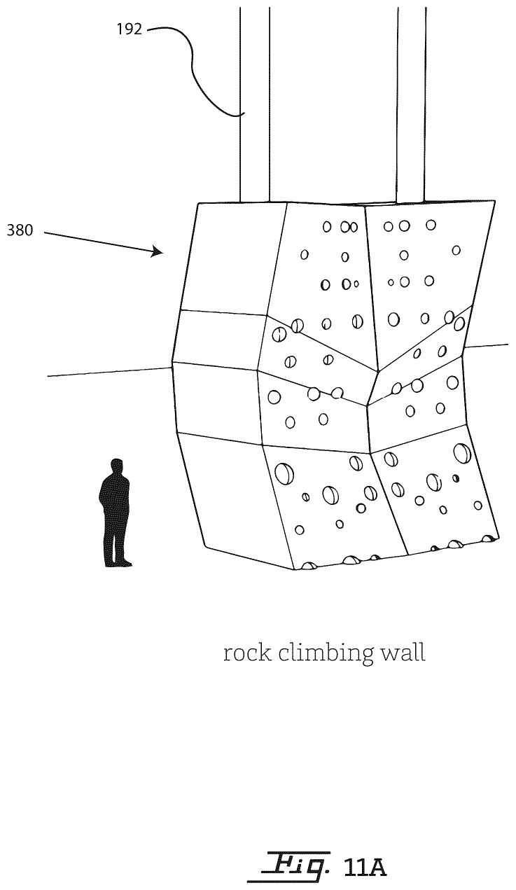

FIG. 11 A shows the same rock-climbing wall having been connected to existing building posts 192 so as to provide permanent stability to a structure. FIG. 11B shows the same rock-climbing wall position against the side of the building.

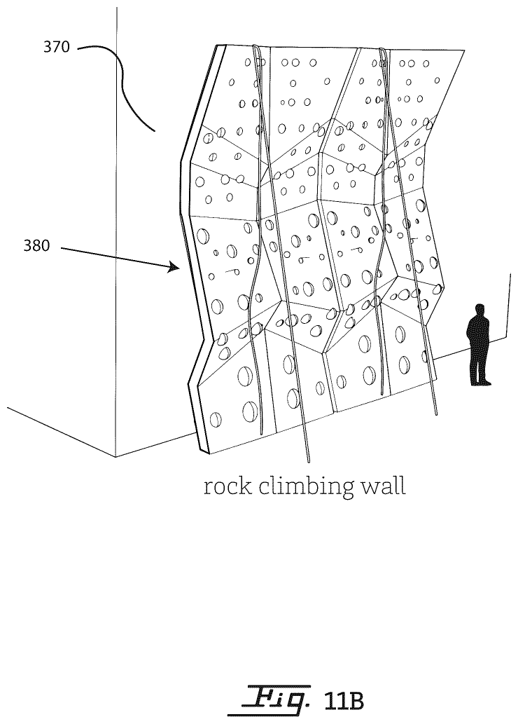

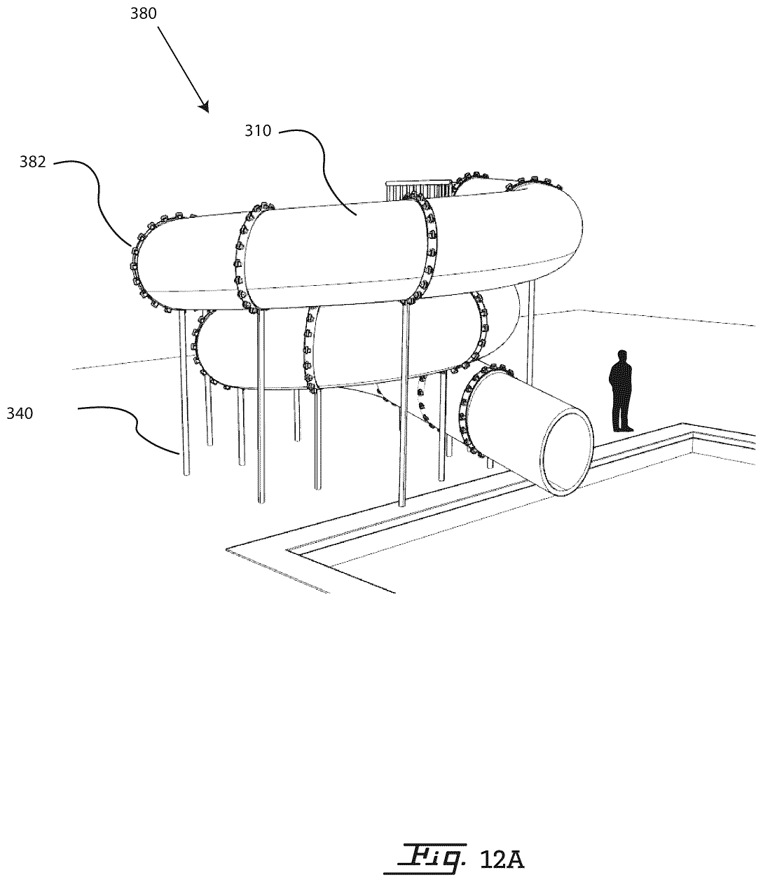

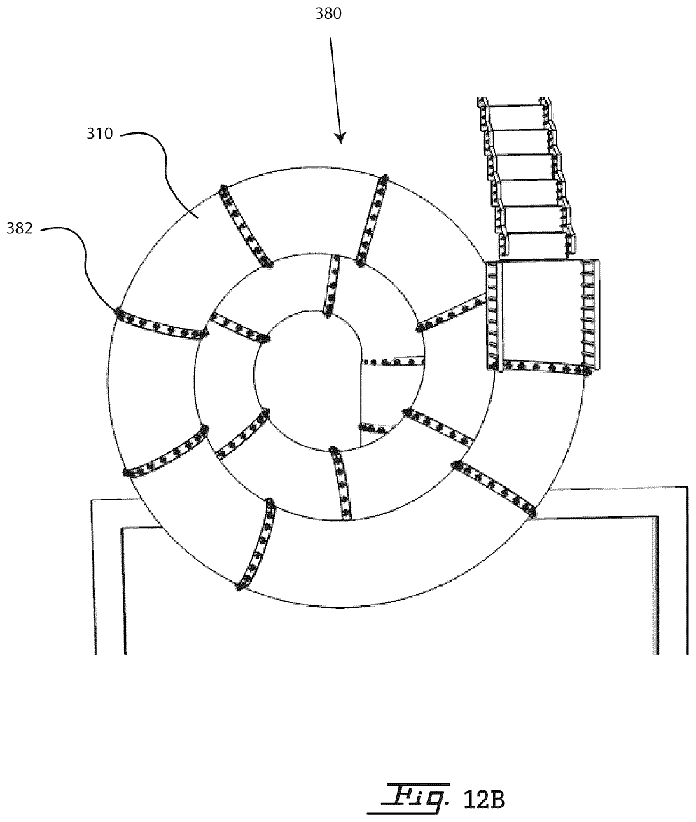

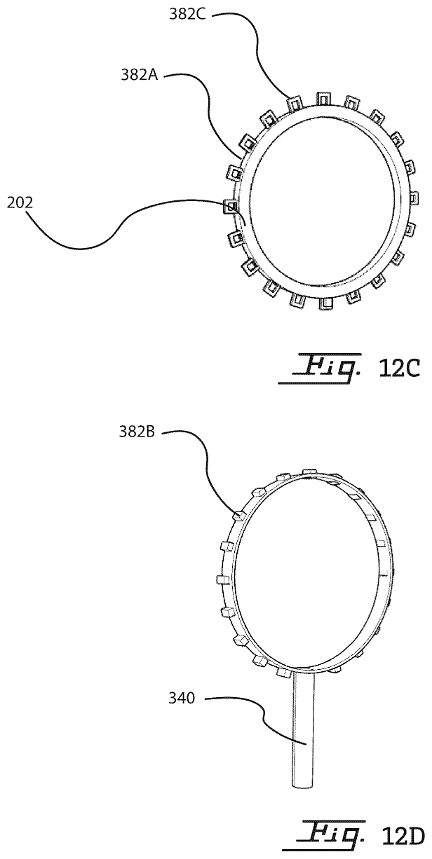

FIG. 12A shows a modular panel system in the form of a recreational water slide. Printed modular panels 310 may take a cylindrical shape so as to create a water slide.

Multiple printed modular panels 310 may be connected in a variety of methods including flanged joints 382 as shown. In this example, Armatures 340 are provided for vertical support. FIG. 12B shows a bird's eye view of FIG. 12A. FIG. 12C shows joint slots 382C, which may be added to the printed material 382A to be discussed later. FIG. 12 D shows the opposing side of flange joint 382, more specifically showing joint protrusions 382B and armature 340.

FIG. 13A shows a company having modular facade system on the face of their building.

FIG. 13B shows a close up of an exemplary modular facade system 400 wherein the shape is nonlinear. The modular facade system may be attached to building 194.

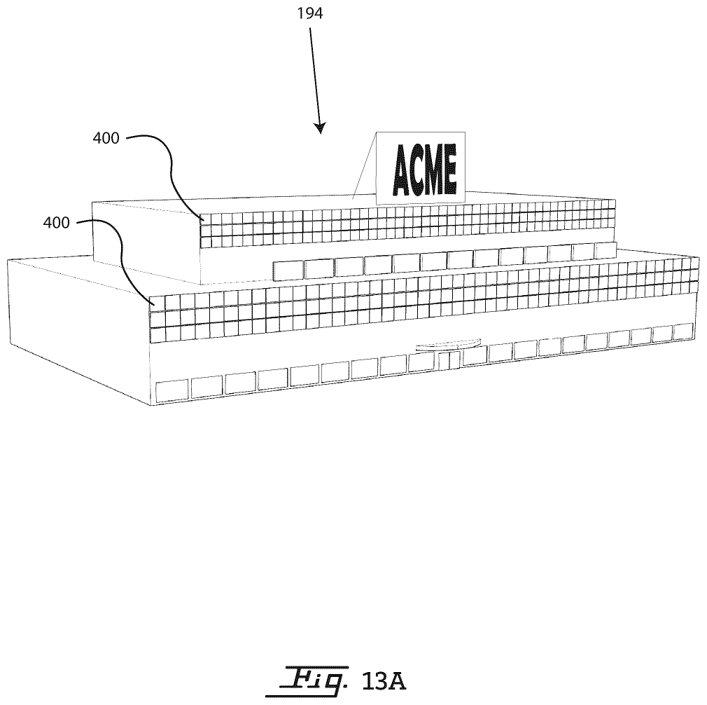

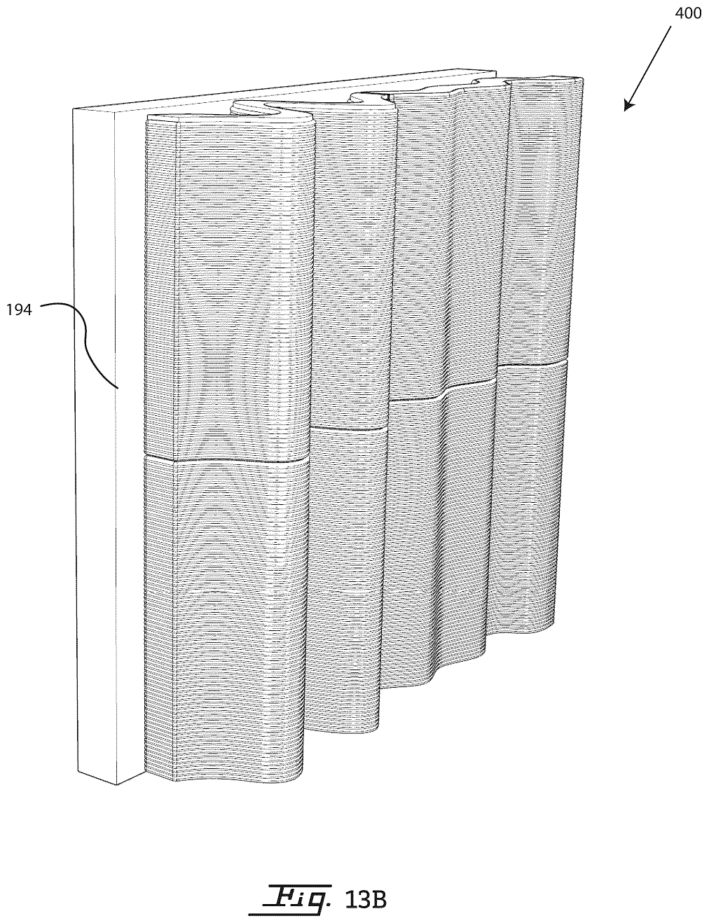

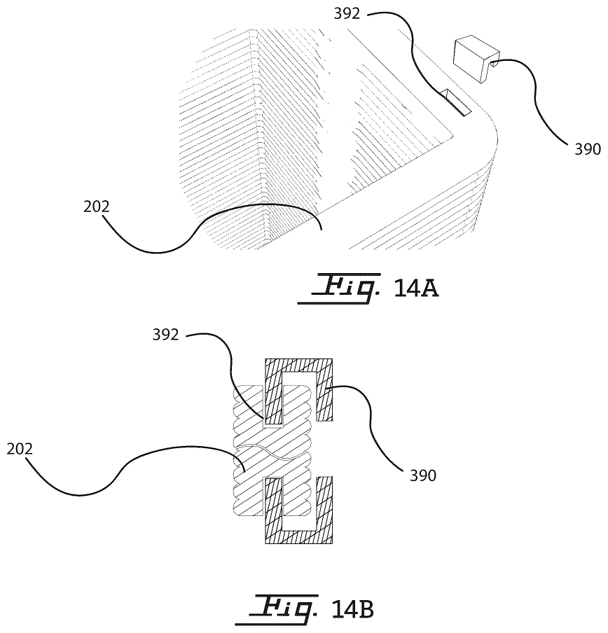

FIG. 14A shows an exemplary method for attaching the modular facade system to a wall or building by the use of retention clips 390 to be received into retention recesses 392. FIG. 14B shows a cross-sectional view of FIG. 14A.

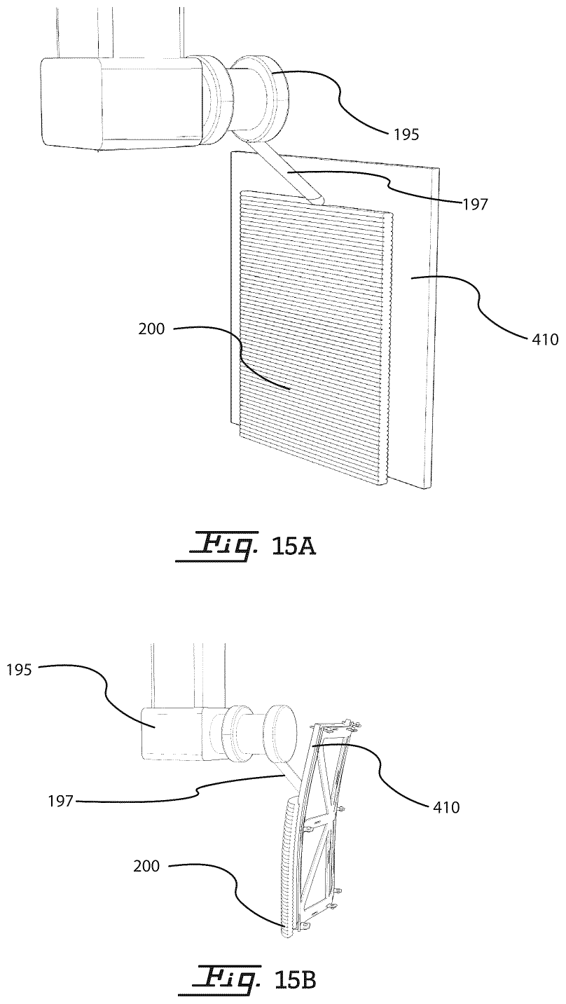

FIG. 15A shows printhead 195 and print Nozzle 197, wherein the print nozzle 197 is guided against print form 410 to dictate the ultimate shape of printed base structure 200. FIG. 15B shows an alternative configuration of FIG. 15A wherein the print form is curved.

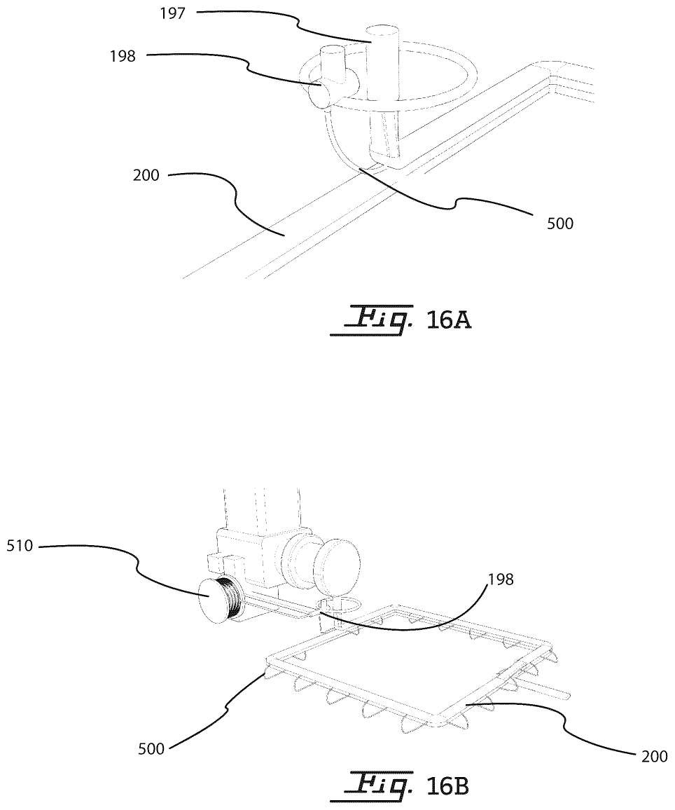

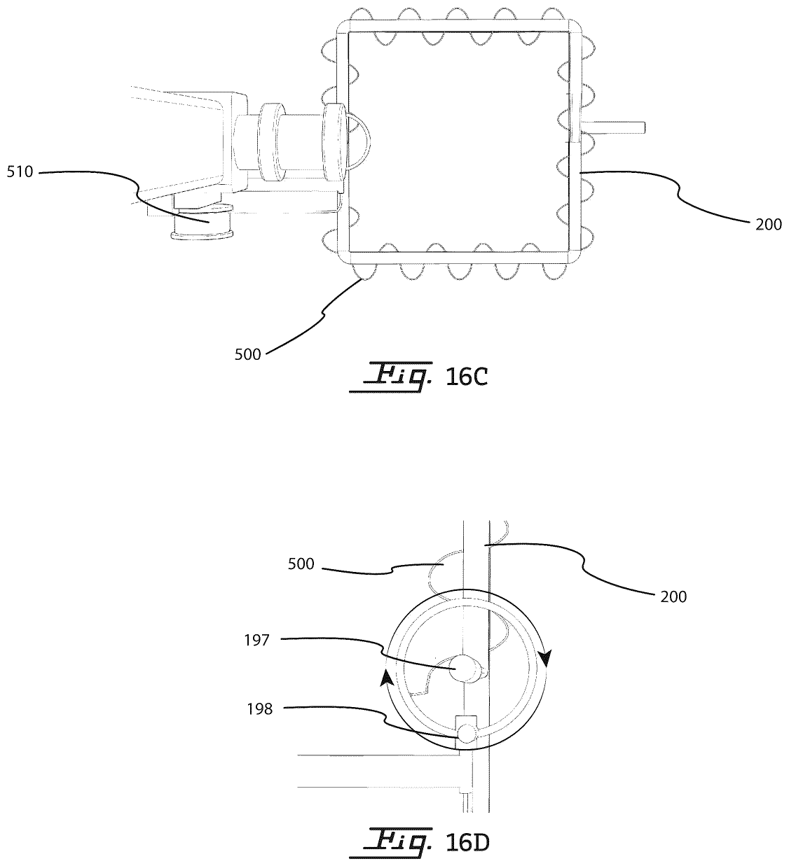

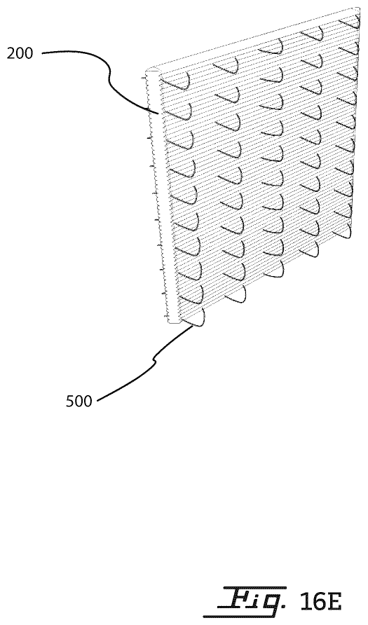

FIG. 16A shows the print nozzle 197 and a lay down feeder 198 that can lay down plurality of feeder stock 500 for a variety of purposes. As shown in FIG. 16A, the feeder stock 500 is a semi-rigid material to provide both strength and attachment means, as shown in FIG. 16B. FIG. 16B shows feedstock material being provided from a spool 510 which is attached to the printer head. FIG. 16C shows a bird's eye view of FIG. 16B. FIG. 16D shows a close-up to illustrate the oscillating lay down pattern of lay down feeder 198 so as to create the design depicted in FIG. 16C. FIG. 16E shows a printed base structure 200 having feeder stock material 500 protruding therefrom so as to provide attachment means.

In another embodiment, a rotating digital impression head or other manipulator/actuator may follow the print head and manipulate the base coat/printed material to form a final coat.

FIG. 17 shows the structure of FIG. 16E with the addition of a vapor barrier material 510 and an insulation barrier 520 as may be suitable in some construction projects, for example, commercial buildings.

FIG. 18 shows how feeder stock 500 may be formed and shaped in a way to receive a variety of construction materials, including plumbing 530A and electrical 530B, as is common in the construction of commercial buildings.

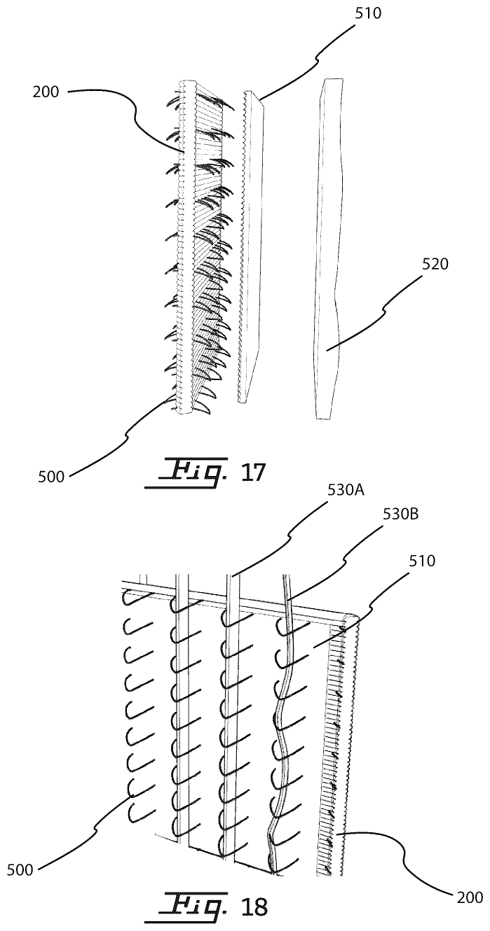

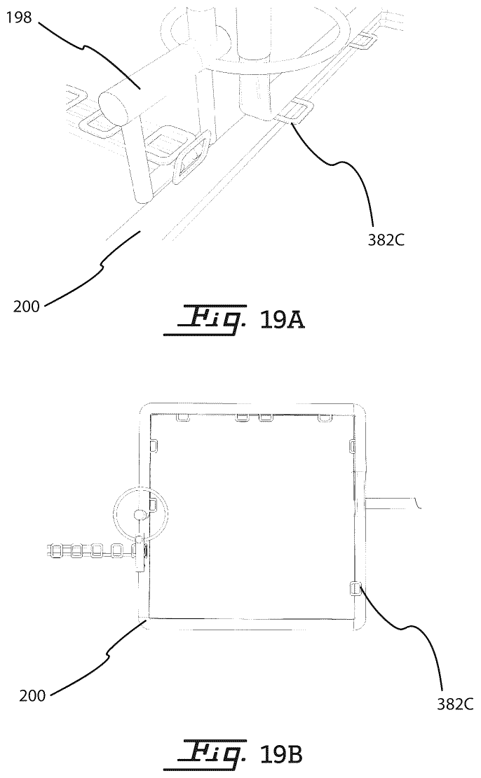

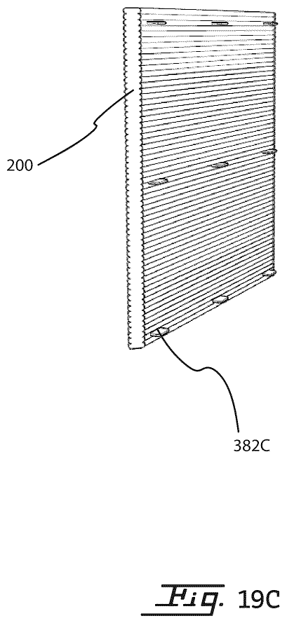

FIG. 19A shows an alternative feeder stock material in the form of joint Tabs 382C so as to provide an alternate connection mechanism. FIG. 19B shows a bird's eye view of joint tabs 382C being applied within printed base structure 200. FIG. 19C shows printed base structure 200 with the joint tabs 382C protruding outwardly for subsequent connection.

FIG. 20A shows a printed base structure 200 having printed corners 312 for subsequent separation along those lines as shown in FIG. 20B. In this approach, multiple panels can be printed from a single print job.

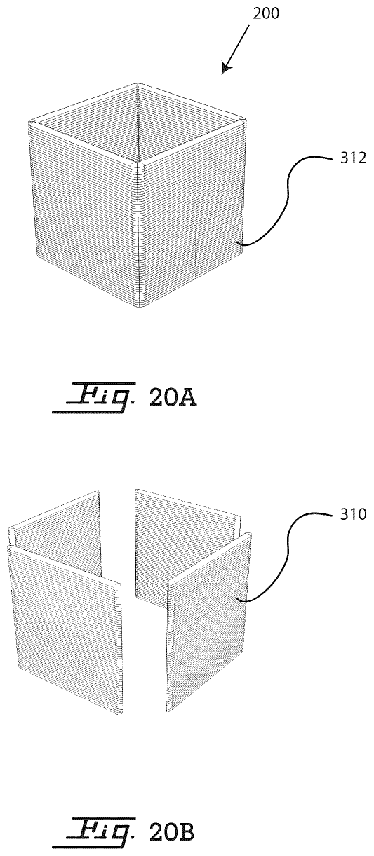

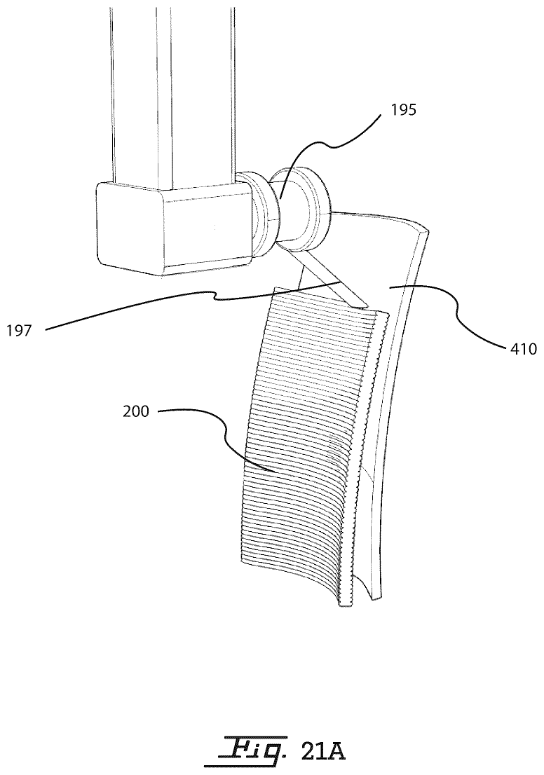

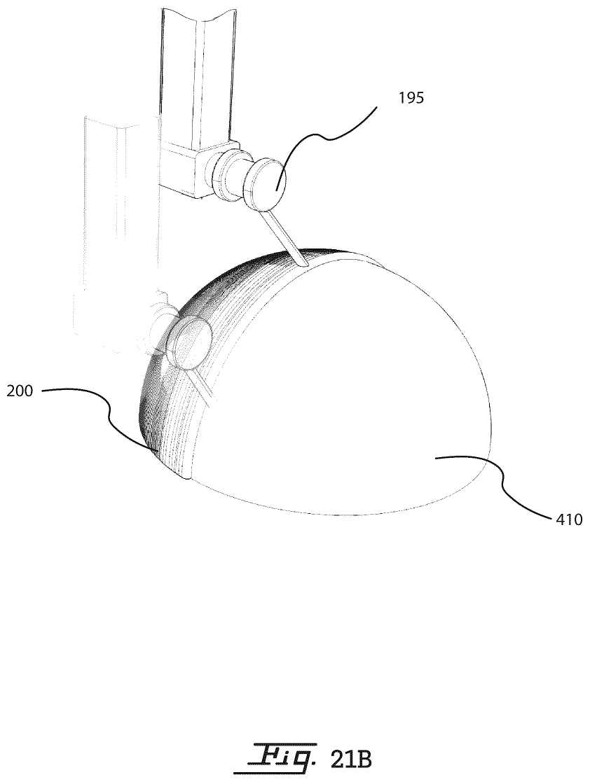

FIG. 21A shows the print form 410 being curved in a concave manner. FIG. 21B shows a print form 410 that is convex.

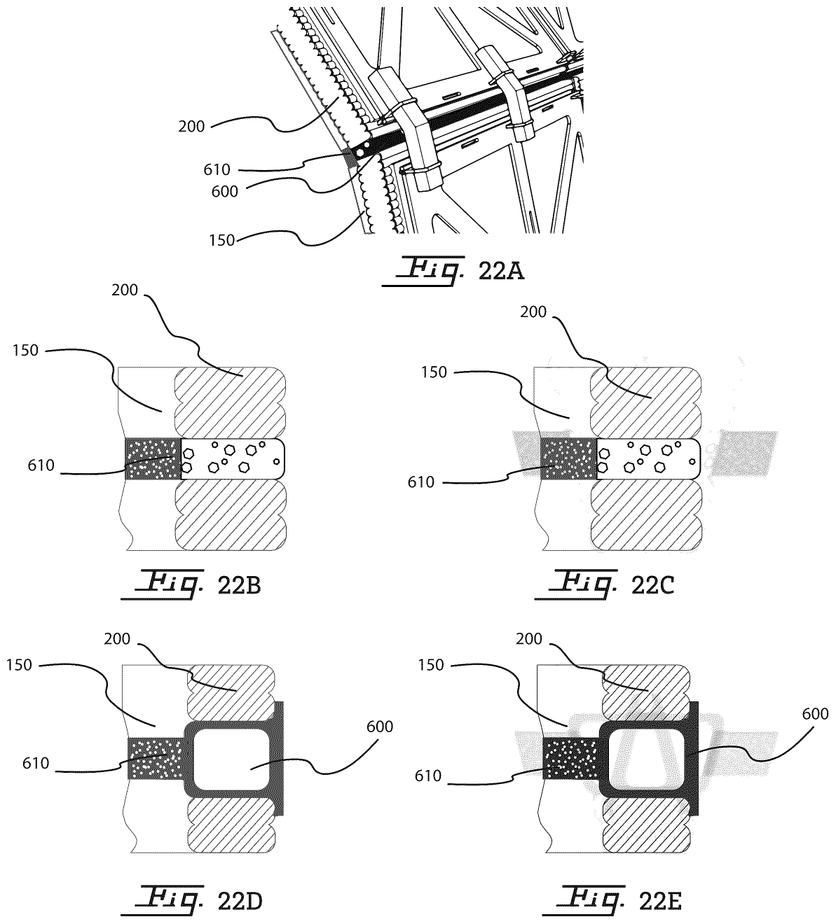

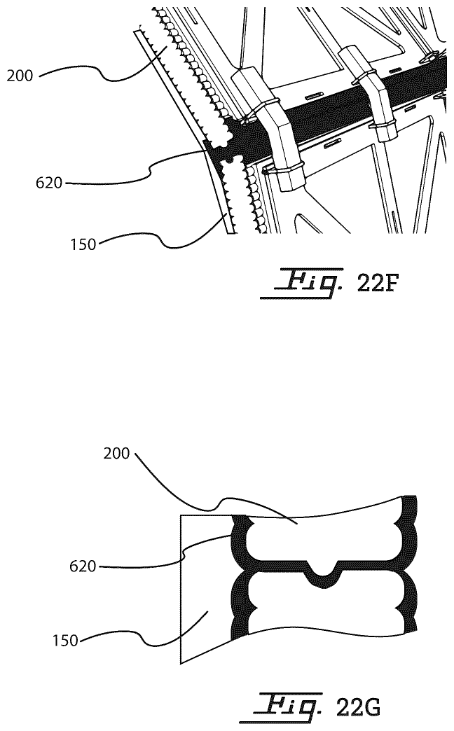

FIG. 22A shows the use of an expansion joint 600 and a cold Joint 610 so as to support the combining of multiple printed base structures 200 and their corresponding artistic final coat 150. FIG. 22B shows cold joint 610 in place prior to a seismic load (or other cyclic load), whereas FIG. 22C shows how the overall structure might successfully endure a seismic load by the benefit of the expansion joint 600. FIG. 22D shows the use of an expansion joint in an alternative form.

FIG. 22E shows the same undergoing a seismic load. FIG. 22F shows the use of a waterproof coating 620 that could provide additional waterproofing for the overall structure. FIG. 22G shows the same waterproof coating 620 of FIG. 22F. FIG. 23A shows an example of an alignment assembly 630 that may be introduced into the printing of printed base structure 200.

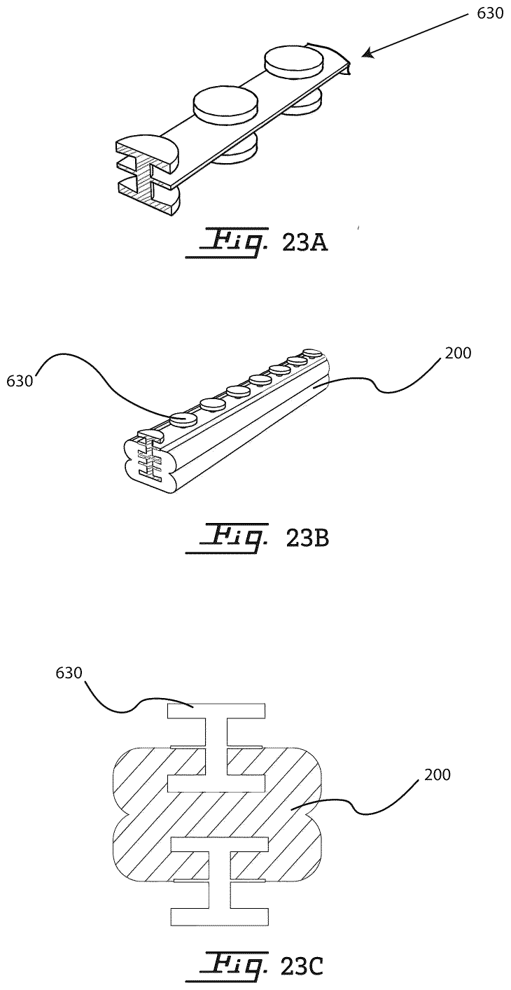

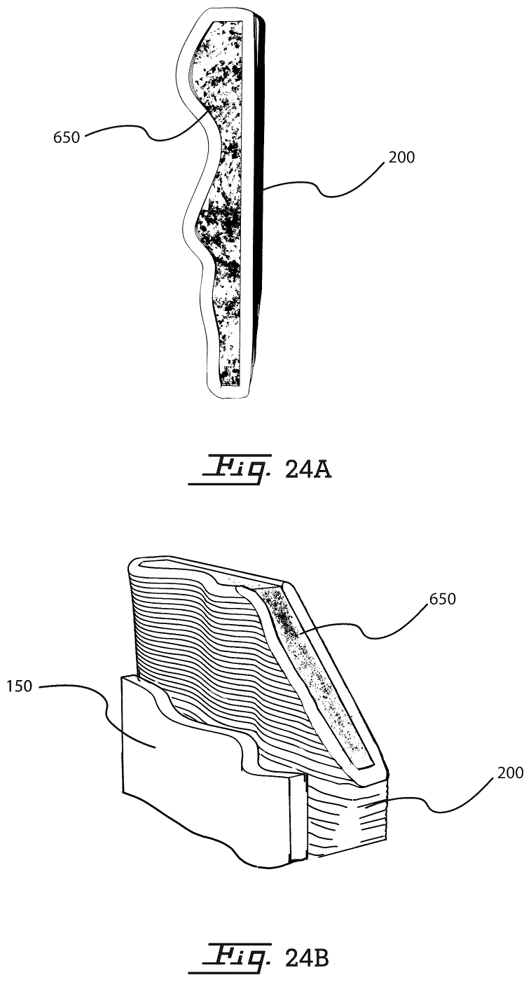

FIG. 23C shows how a cross-sectional view of FIG. 23B. FIG. 24A shows a printed base structure 200 having strengthening material 650 being applied internally. This strengthening material 650 may provide greater structural integrity and strength as may be required in a variety of applications, including benches, columns, and the like Examples of strengthening materials include, but are not limited to, one or more of the following: Kevlar, Bassalt fiber, steel fiber, glass fiber, and carbon fiber.

FIG. 24B shows a cutaway of FIG. 24A with the addition of an artistic final coat 150 being applied.

FIG. 25A shows the modular panel system 380 undergoing an earthquake and seismic load.

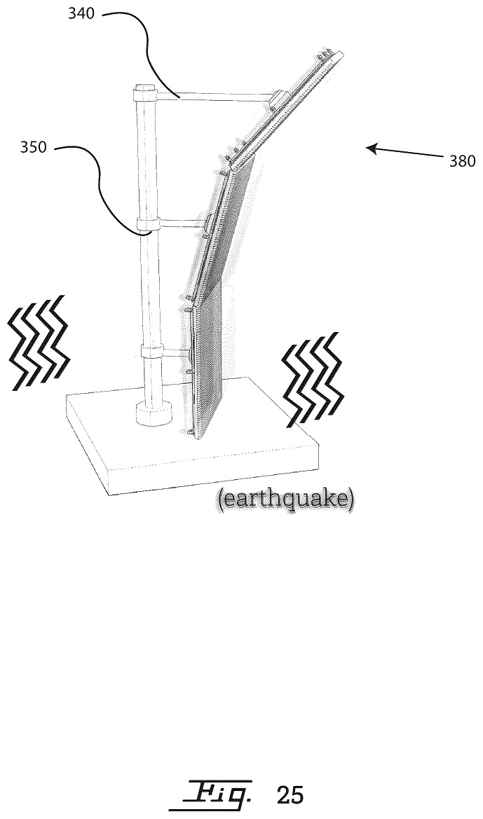

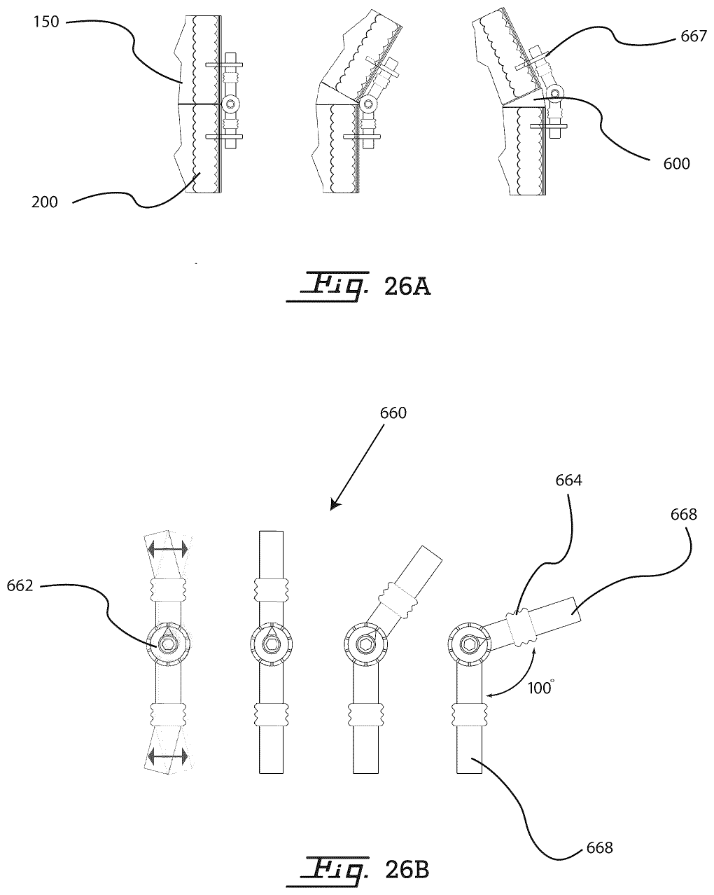

FIG. 26A shows the introduction of mounting brackets 667 to be applied to the panels together with adjustable braces 660 as shown in FIG. 26B, adjustable braces 660 may be configured to achieve a variety of angles to achieve the desired look. Adjustable dial 662 may be utilized so as to aid in the installation and achievement of the desired angles, as is also shown in FIG. 26 B. A dampener 664 may be utilized in combination with sliding rod 668 so as to provide further dampening during seismic loads and other disturbances.

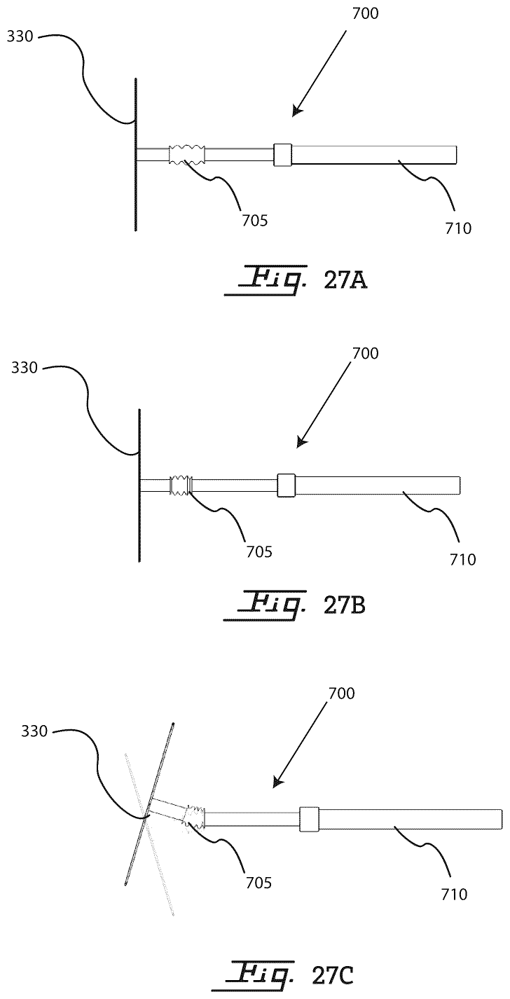

FIG. 27A shows an example of a seismic safety assembly 700 having both a seismic dampener 705 and a seismic rod 710. FIG. 27B shows the seismic safety assembly 700 of FIG. 27A undergoing a seismic load. FIG. 27C shows the same seismic safety assembly 700 undergoing a nonlinear applied force. FIG. 27D shows a seismic safety assembly 700 with the use of multiple assemblies to achieve greater structural support.

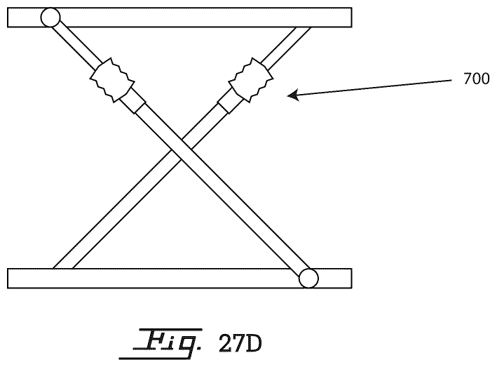

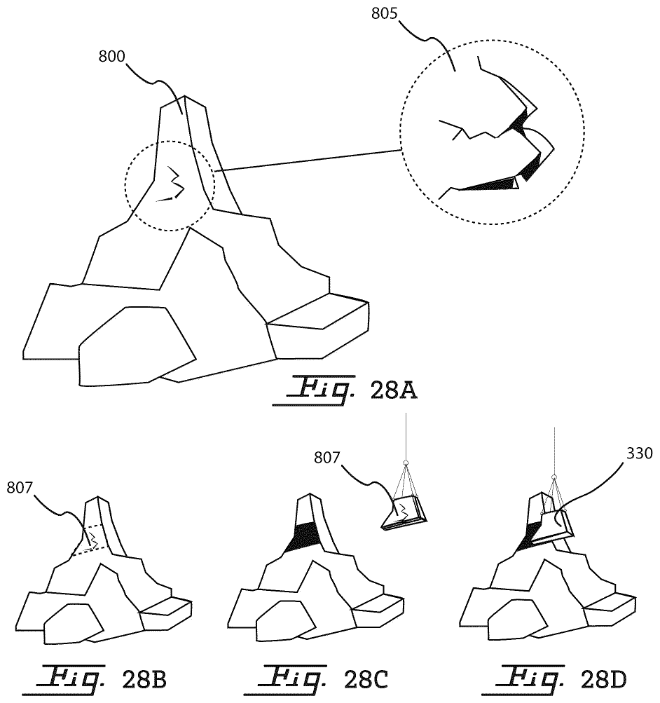

FIG. 28A shows an existing rock formation 800 which may be commonly found in many amusement parks and other locations around the world, a crack is often found 805 and requiring of a repair, but the repairing of said crack is made significantly easier in one or more embodiments. FIG. 28D shows a cracked section 807 to be removed as shown in FIG. 28C. FIG. 28D shows the insertion of a supported printed panel 330 in accordance with one or more embodiments.

In another embodiment, the panel shown as having a crack may alternatively comprise at least one replaceable panel (e.g., seasonal panels that are interchanged to change the aesthetic appearance of the formation design). Similar to FIGS. 28A through 28D, the at least one replaceable panel(s) may be replaced and stored for later use in the formation.

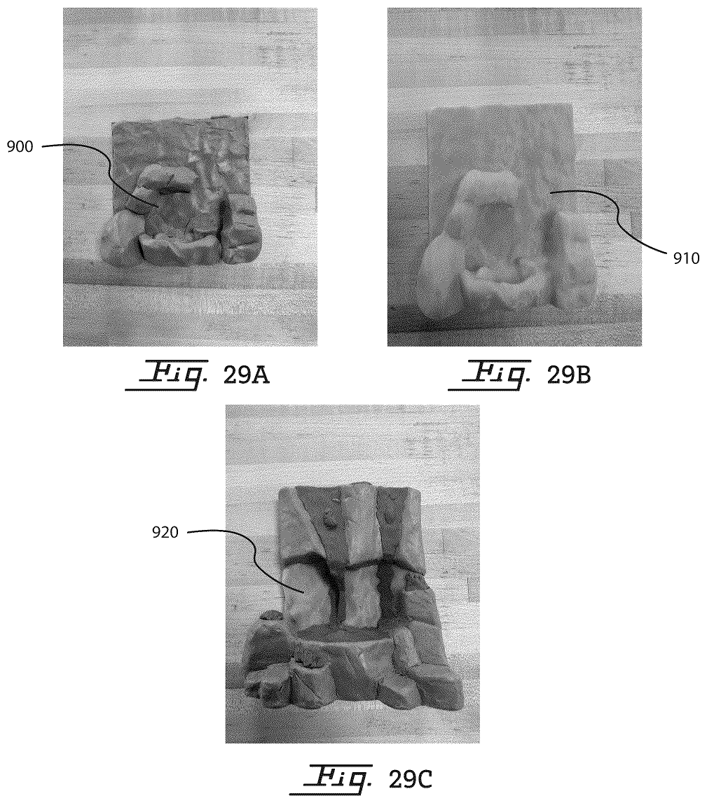

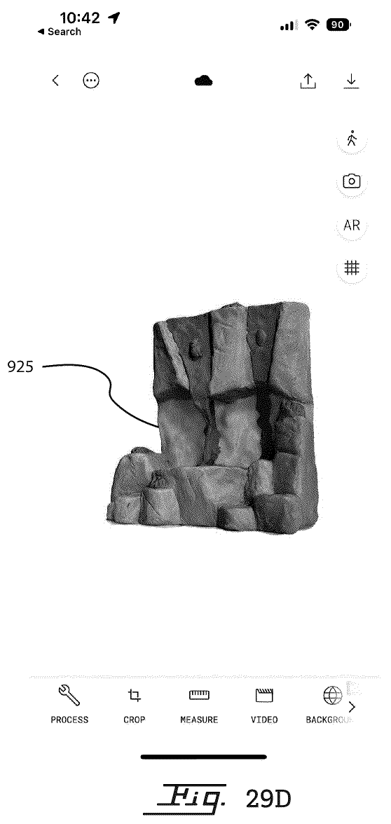

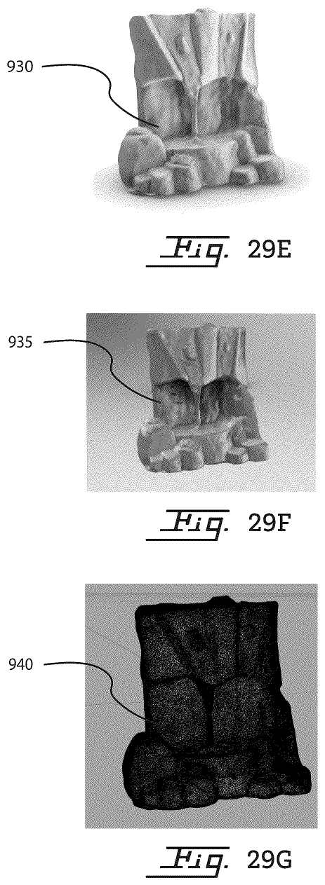

FIG. 29A shows a clay model 900 which may be 1 of a variety of methods in the original designing of the desired themed wall. FIG. 29B shows a printed model 910 which may be printed from a small 3D printer so as to mimic that of the clay model 900. FIG. 29C shows how printed model 910 may be decorated to become decorated. Printed model 920 so as to confirm the desired appearance. FIG. 29D shows a digital scan 925 which may later be used in the print production. FIG. 29E shows a digital rendering of the scan 920. This digital rendering 930 is used in the software for 3D printing. FIG. 29F shows the output of an overhang analysis 935 to confirm the structural integrity of the 3D printed structure before it's printed. FIG. 29G shows a mesh analysis 940 which seeks to confirm how successful the subsequent decoration by the artist will be.

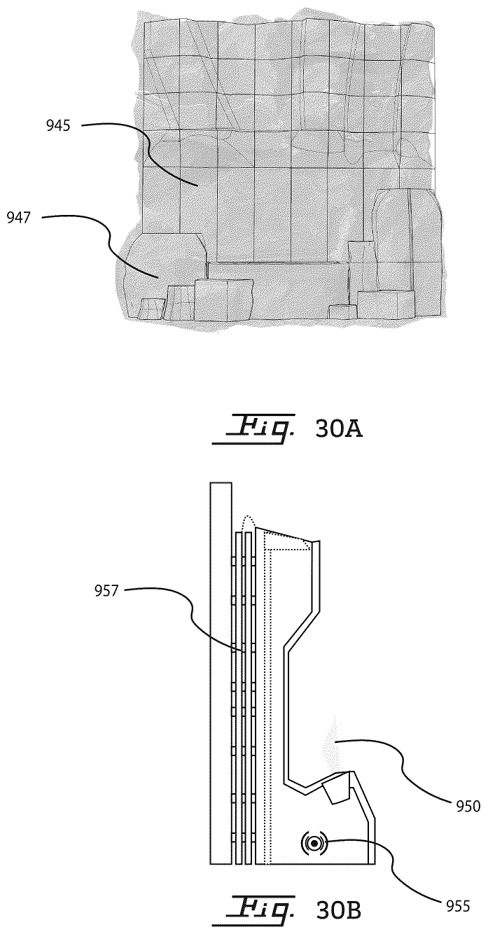

FIG. 30A shows a subdivision analysis 945 so as to identify the multiple structures that may need to be printed, for example, freestanding structures 947. FIG. 30B shows how a variety of construction materials MEP, open print, mechanical, electrical, plumbing closed print 957 may be incorporated in the overall printed design. Also shown in this design is the introduction of light and other light sources such as fire 950 in addition, a sound speaker 955 may be part of the assembly to provide further entertainment to the audience.

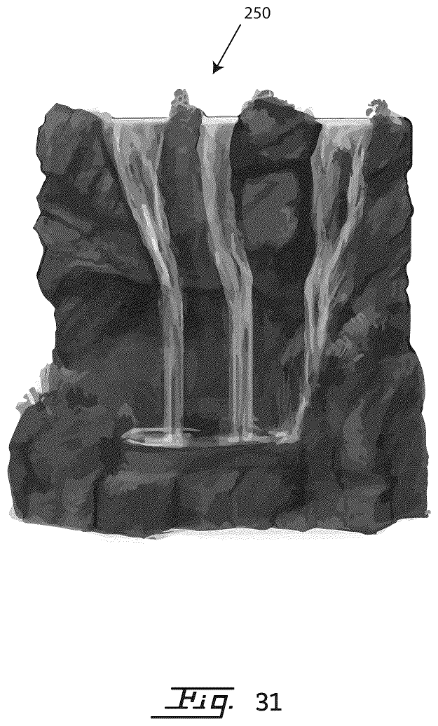

FIG. 31 shows the final appearance of the assembled printed products of FIG. 30B.

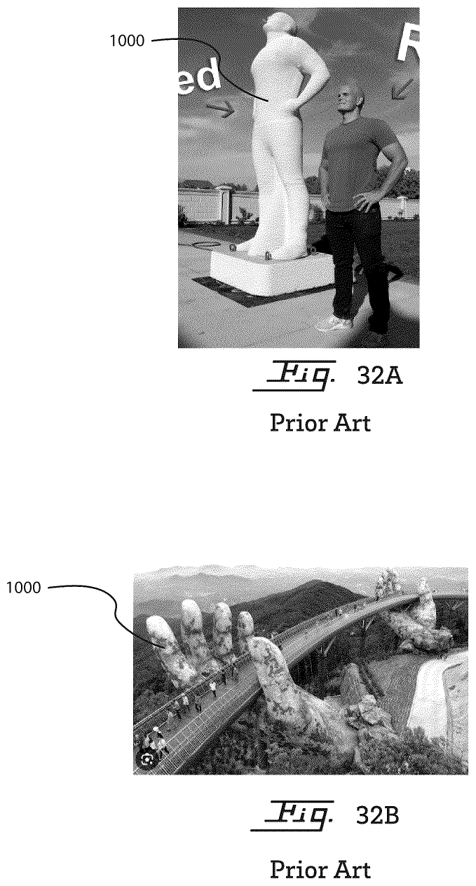

FIG. 32A shows a larger than life statue that was printed by the inventor here. This printed statue 1000 may serve as the printed base structural for further decoration, as can be shown in an example. FIG. 32B as one in the art would appreciate, one or more embodiments provided may also be used to create a whole variety of statues and animated objects commonly found in the public and amusement parks.

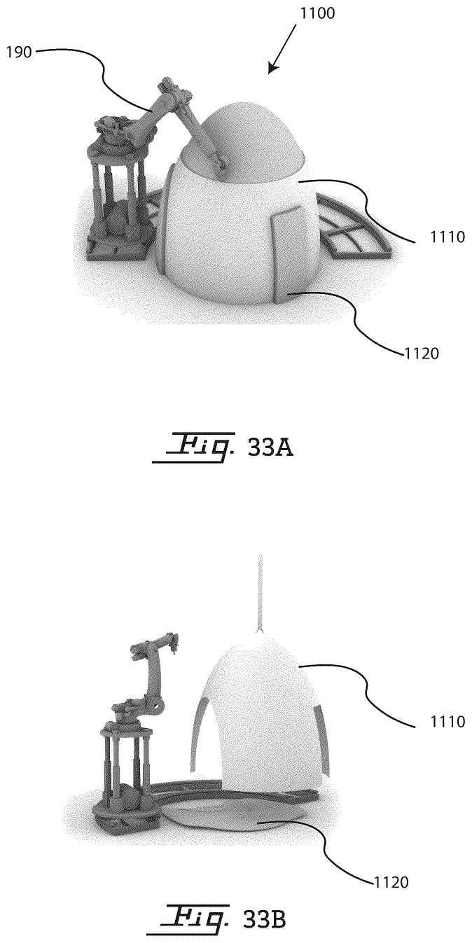

FIG. 33A shows an alternative application wherein a printed dwelling 1100 is formed. More specifically, a 3D printer, such as a robotic 3D printer 190 may print a printed wall structure 1110 using a disposable print form 1120 as shown in FIG. 33A.

FIG. 33B shows how the disposable print form 1120 can subsequently be removed after the printing is completed so as to result in a fully printed dwelling 1100.

While the above embodiments have illustrated a printed base structure adapted for the subsequent decoration by an artist in accordance with the present invention, one skilled in the art would appreciate that a variety of sizes and shapes and form factors would be in keeping with the teachings of the present invention.

One skilled in the art would appreciate that the term “artist” is meant generally to be anyone who would otherwise apply an artistic final coat to the printed base structure.

What is claimed is:

1. A printed base structure adapted for the subsequent decoration by an artist, comprising:
a printed base structure adapted for the subsequent decoration by an artist;
said printed base structure having a plurality of layers of a printable material.

2. The structure of claim 1, wherein said layers of printable material having at least one side being non-linear.

3. The structure of claim 2, further comprising a decorated printed structure being affixed to said printed base structure.

4. The structure of claim 3, wherein said decorated printed structure being applied by hand.

5. The structure of claim 3, wherein said decorated printed structure being applied by a robot.

6. The structure of claim 3, further comprising a strengthening material being inserted into said printed base structure so as to provide greater structural integrity.

7. The structure of claim 3, further comprising a light source being fixable attached to said printed base structure.

8. The structure of claim 3, further comprising a fire source being integrally provided to said printed base structure.

9. The structure of claim 3, further comprising a sound speaker source being integrally provided to said printed base structure.

10. The structure of claim 3, wherein said printed base structure being adapted to subsequently become a decorated themed wall.

11. The structure of claim 3, wherein said printed base structure being adapted to subsequently become a decorated water fountain.

12. The structure of claim 3, wherein said printed base structure being adapted to subsequently become a decorated water slide.

13. The structure of claim 3, wherein said printed base structure being adapted to subsequently become a decorated statue.

14. A printed base structure adapted for the subsequent decoration by an artist, comprising:
a printed base structure adapted for the subsequent decoration by an artist;
said printed base structure being constructed of a plurality of structure segments.

15. The structure of claim 14, further comprising a decorated printed structure being affixed to said printed base structure.

16. The structure of claim 15, wherein said decorated printed structure being applied by hand.

17. The structure of claim 15, wherein said decorated printed structure being applied by a robot.

18. A printed modular assembly adapted for the subsequent decoration by an artist, comprising:
a printed modular panels adapted for the subsequent decoration by an artist;
said printed modular assembly being constructed of a plurality of printed modular panels; and
modular supports being affixed to said printed modular panels.

19. The assembly of claim 18, further comprising panel brackets being printed integral to said printed modular panels.

20. The assembly of claim 19, further comprising attachment hardware being adapted to connect and engage with said panel brackets.

21. The assembly of claim 20, further comprising an armature adapted to structurally support printed modular panels.

22. The assembly of claim 21, further comprising a post adapted to provide substantially-vertical support for said armature.

23. The assembly of claim 22, further comprising a strut to provide protection against seismic loading.

24. The assembly of claim 23, further comprising a flanged joint to secure a plurality of printed modular panels together.

25. The assembly of claim 23, further comprising a expansion joint adapted to provide stress protection between said printed modular panels.

26. A printed dwelling being able to be printed at a remote location, comprising:
a printed wall structure adapted to provide the benefits of a dwelling; and
a disposable print form that allows for the printing of said printed wall structure; said disposable print form being disposable after the completion of said printing.

27. The structure of claim 3, wherein said printed base structure being adapted to subsequently become a decorated rock climbing wall.

28. The structure of claim 1, wherein at least a portion of the printed base structure is manipulated after being printed to form a final coat of the printed base structure.

29. The structure of claim 1, wherein the printed base structure is greater than 7 feet tall and greater than 7 feet wide.

30. The structure of claim 1, wherein the printed base structure is greater than 8 feet tall and greater than 8 feet wide.

31. The structure of claim 1, wherein the printed base structure includes joinery configured to attach the panel to a second printed base structure or a field-bent bar structure.
